(19) United States
(12) Patent Application Publication
(10) Pub. No.: US 2016/0288439 A1
(43) Pub. Date: Oct. 6, 2016

(54) SYSTEM AND METHOD FOR REPRODUCING MOLDED INSOLE

(71) Applicant: Zero Gravity Inside Inc., National City, CA (US)

(72) Inventor: Patrik Louko, Helsinki (FI)

(21) Appl. No.: 14/675,553

(22) Filed: Mar. 31, 2015

(51) Int. Cl. B29D 35/12; A43D 1/08; H04N 5/225; G05B 19/4099; H04N 13/02; A43B 17/00; B29C 67/00

(52) U.S. Cl. CPC B29D 35/122; A43B 17/003; A43D 1/08; B29D 35/128; B29C 67/0088; G05B 19/4099; H04N 13/0282; H04N 5/2253; B33Y 10/00

(57) ABSTRACT

A method of reproducing at least one previously molded insole is disclosed. In one aspect, the method includes generating a scanned image of the molded insole, three-dimensionally printing a mold based on the scanned image and reproducing a molded insole, based on the printed mold, which is substantially the same as the previously molded insole.

### RELATED APPLICATIONS

This application relates to i) U.S. patent application entitled “Moldable Footwear Insole” (Attorney Docket No. ZGI.002A) and ii) U.S. patent application entitled “Apparatus and Method for Custom Molding an Insole” (Attorney Docket No. ZGI.003A) concurrently filed with this application, both of which are incorporated herein by reference.

### BACKGROUND

1. Field

The described technology generally relates to a system and method for reproducing a molded insole.

2. Description of the Related Technology

A shoe insole or insole refers to an insert with a cushion layer which is fitted into a shoe. Insoles are widely used to provide support and comfort. To provide an optimized comfort to a specific foot, custom-made insoles have been developed. Custom insoles can be made by molding insoles using a person's feet. These customized insoles are generally more comfortable than mass produced insoles that have been pre-made.

### SUMMARY

The apparatuses and systems of the present disclosure have several features, no single one of which is solely responsibly for its desirable attributes. Without limiting the scope of the described technology as expressed by the claims which follow, its more prominent features will now be discussed briefly. After considering this discussion, and particularly after reading the section entitled “Detailed Description,” one will understand how the features of this disclosure provide several advantages over current insole molding technologies.

One inventive aspect is a method of reproducing at least one previously molded insole, comprising: generating a scanned image of the molded insole; three-dimensionally printing a mold based on the scanned image; and reproducing a molded insole, based on the printed mold, which is substantially the same as the previously molded insole.

Another aspect is a system for reproducing at least one previously molded insole, comprising: a three-dimensional (3D) scanner configured to generate a scanned image of the molded insole; and a 3D printer configured to three-dimensionally print at least one mold based on the scanned image so as to reproduce at least one molded insole, based on the printed mold, which is substantially the same as the previously molded insole.

Another aspect is a three-dimensional scanner for scanning a molded insole including rearfoot, midfoot and forefoot portions, the scanner comprising: a support structure; a head connected to a top portion of the support structure; and a camera attached to the head and configured to be positioned above the insole, wherein the camera is configured to three-dimensionally scan at least the rearfoot and midfoot portions of the insole.

Another aspect is a method of reproducing at least one previously molded insole, comprising: providing a first mold having a shape of a partial insole; providing a second mold having substantially the same in shape and size as the first mold, wherein each of the first and second molds includes a rearfoot portion and a midfoot portion but does not include a forefoot portion; placing a non-molded insole, including a forefoot portion, a midfoot portion and a rearfoot portion, between the first and second molds such that the rearfoot and midfoot portions of the first and second molds substantially align the rearfoot and midfoot portions of the non-molded insole, wherein the first mold is placed over the second mold; and pressing at least one of the first and second molds until the midfoot and rearfoot portions of the non-molded insole are respectively substantially the same in shape as the midfoot and rearfoot portions of the first and second molds.

Another aspect is a molded insole manufactured by the above method.

### BRIEF DESCRIPTION OF THE DRAWINGS

The above mentioned and other features of this disclosure will now be described with reference to the drawings of several embodiments of a method of reproducing at least one previously molded insole, a system for reproducing at least one previously molded insole, a three-dimensional scanner for scanning at least one molded insole and a mold manufactured by the method. The illustrated embodiments of the apparatuses and methods are intended to illustrate, but not to limit the disclosure. The drawings contain the following figures:

FIG. 1 is a conceptual drawing showing how to reproduce a previously molded insole according to one embodiment.

FIG. 2A is a top view of an example of previously molded insoles according to one embodiment.

FIG. 2B is a bottom view of the molded insoles of FIG. 2A.

FIG. 3A illustrates an example of a three-dimensional (3D) scanner for 3D scanning molded insoles according to one embodiment.

FIG. 3B illustrates the 3D scanner of FIG. 3A on which a pair of molded insoles to be 3D scanned are placed.

FIG. 4A illustrates an example of a 3D scanner for 3D scanning molded insoles according to another embodiment.

FIG. 4B is a detailed view of the camera of the 3D scanner of FIG. 4A.

FIG. 4C illustrates the 3D scanner of FIG. 4A on which a pair of molded insoles to be 3D scanned are placed.

FIG. 5 illustrates an example of a 3D scanner for 3D scanning molded insoles according to another embodiment.

FIG. 6 is a flowchart showing an example of an operation of a method of reproducing molded insoles.

FIG. 7A is an example of a screenshot of an initial set-up screen of the 3D scanning program according to one embodiment.

FIG. 7B is an example of a screenshot of the molded insoles displayed on the computing device of FIG. 1 before the 3D scanner scans the molded insoles according to one embodiment.

FIG. 7C is an example of a screenshot of the molded insoles displayed on the computing device of FIG. 1 after the 3D scanner scanned the molded insoles according to one embodiment.

FIG. 7D is an example of a screenshot for storing a 3D scanned image as an STL file for processing according to one embodiment.

FIGS. 8A-8N are examples of screenshots showing how the scanned image is processed for 3D printing according to one embodiment.

FIG. 9 is an example of a screenshot of an initial screen of the 3D printing program according to one embodiment.

FIGS. 10A-10I are examples of screenshots showing how the scanned and stored images are additionally processed before 3D printing according to one embodiment.

FIG. 11 illustrates an example of a 3D printer for printing one or more molds for reproducing molded insoles according to one embodiment.

FIG. 12A illustrates an example of a mold printed by the 3D printer of FIG. 11 for reproducing the molded insole according to one embodiment.

FIG. 12B illustrates examples of molds having different sizes printed by the 3D printer of FIG. 11 according to one embodiment.

FIG. 12C illustrates examples of molds having the same size printed by the 3D printer of FIG. 11 according to one embodiment.

FIG. 13A illustrates examples of molds having the same size printed by the 3D printer of FIG. 11 and a non-molded insole to be molded by the example molds according to one embodiment.

FIG. 13B illustrates the non-molded insole interposed by the molds having the same size for molding the non-molded insole according to one embodiment.

FIG. 13C illustrates the interposed insole and a presser for pressing the molds for molding the insole according to one embodiment.

FIGS. 13D and 13E illustrate the non-molded insole being pressed by the presser of FIG. 13C for molding the non-molded insole according to one embodiment.

FIG. 14 is a flowchart showing an example of an insole purchasing procedure according to one embodiment.

FIG. 15 is a flowchart showing an example of an insole reproducing procedure according to one embodiment.

### DETAILED DESCRIPTION

When a person wishes to buy additional pair(s) of custom-made insoles, even if the person previously made customized insoles, the person needs to go to a retail store and make insoles again using the same molding method, which is inconvenient and time consuming.

Embodiments will be described with respect to the accompanying drawings. Like reference numerals refer to like elements throughout the detailed description. In this disclosure, the term “substantially” includes the meanings of completely, almost completely or to any significant degree under some applications and in accordance with those skilled in the art. The term “connected” includes an electrical connection.

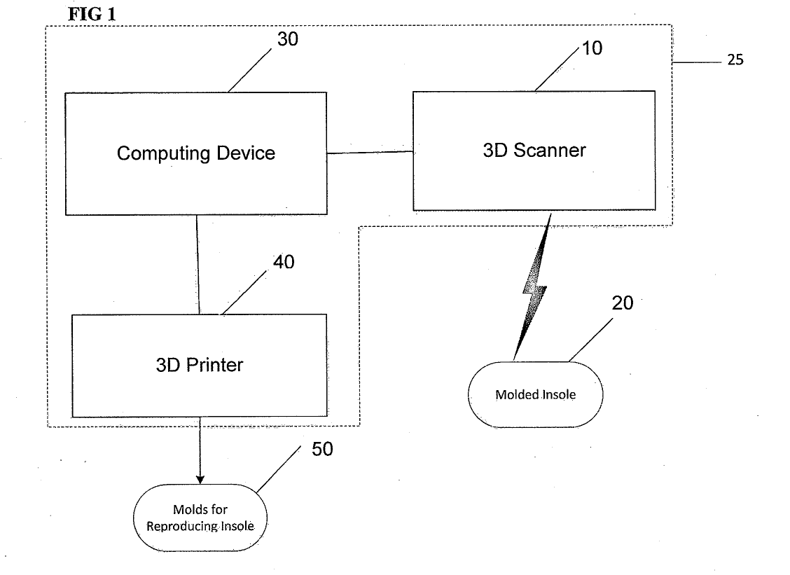

FIG. 1 is a conceptual drawing showing how to reproduce a previously molded insole 20 according to one embodiment. Referring to FIG. 1, a mold generating system 25 obtains, and processes a scanned image of the previously molded insole 20. The mold generating system 25 also generates at least one mold 50 for reproducing a copy of the previously molded insole 20. The generated mold 50 is used to reproduce a molded insole that is substantially identical to or substantially the same as the previously molded insole 20. In some embodiments, the mold generating system 25 includes a three-dimensional (3D) scanner 10, a computing device 30 and a 3D printer 40.

Depending on the embodiments, certain elements may be removed from, or additional elements may be added, to the mold generating system 25 illustrated in FIG. 1. Furthermore, two or more elements may be combined into a single element, or a single element may be realized as multiple elements. This thought applies with equal force to the remaining embodiments. For example, the 3D scanner 10, the computing device 30 and the 3D printer 40 can be integrated into a single system that can scan in 3D, process the scanned image, and print in 3D at least one mold 50 for reproducing a copy of the previously molded insole 20. In another embodiment, any two of the three elements (10, 30, 40) can be combined to form a single system. For example, the 3D scanner 10 and the computing device 30 can be integrated into a single unit. In this embodiment, the 3D scanner 10 can include a processor that can execute a 3D scanning program (e.g., Skanect) that controls the camera of the 3D scanner 10 and also a monitor that displays a camera control procedure. The 3D program can be stored in the 3D scanner 10 or in a separate computing device. In another embodiment, the computing device 30 is integrated into either the 3D scanner 10 or the 3D printer 40. Furthermore, the connection among the elements (10, 30 and 40) in any of the above embodiments can be wired or wireless.

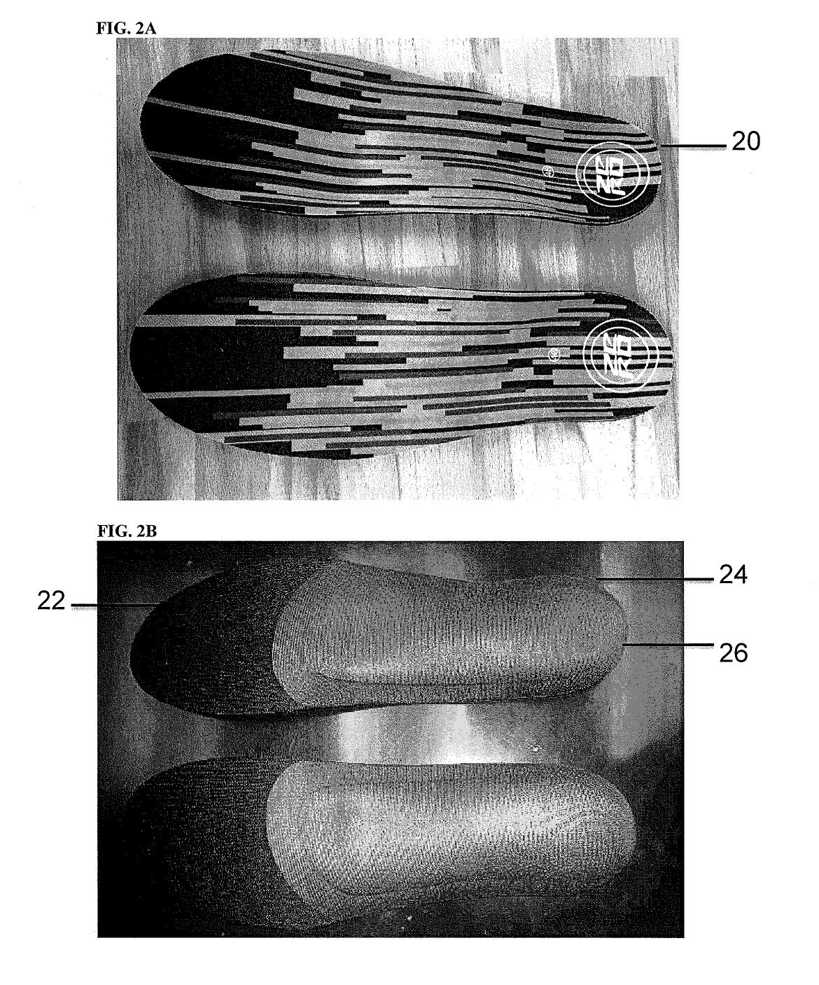

FIG. 2A is a top view of an example of previously molded insoles according to one embodiment. FIG. 2B is a bottom view of the molded insoles of FIG. 2A. The molded insoles 20 can have various structures and configurations. In some embodiments, each of the molded insoles 20 includes multiple layers. For example, as shown in FIG. 2B, each of the molded insoles 20 includes a foam layer 22, a rigid layer 24 and a foundation layer 26. In some embodiments, the rigid layer 24 and the foundation layer 26 are formed only in the rearfoot portion (heal cup portion or heal portion) and the midfoot portion, but not formed in the forefoot (or toe) area. Here, the rear foot portion corresponds to the heel area of a foot and the middle foot portion corresponds to a middle region or an arched portion of the foot extending from an end of the heel area to a region where metatarsophalangeal joints are located. The forefoot portion corresponds to an area extending from metatarsophalangeal joints to toes of a foot. A detailed description of an example non-molded or raw insole is provided in U.S. patent application (Attorney Docket No. ZGI.002A) entitled “Moldable Footwear Insole” (inventor: Patrik Louko) which is concurrently filed with this application and is incorporated herein by reference.

The molded insoles 20 can be generated from a non-molded or raw insole in many different ways. For example, one of the molded insoles 20 is generated by heating a raw insole and having a customer or user place one of his/her feet on the heated insole until the raw insole is molded to the shape of the bottom of the customer's foot, and then the same process is performed for the other foot. At least the midfoot and rearfoot portions of the raw insole can be heated and molded. In another embodiment, the raw insole can be molded by a molding device that includes a foam layer and a gel layer placed over the foam layer both of which can be further enclosed in a flexible cloth. A description of generating a molded insole using an example molding device is provided in U.S. patent application (Attorney Docket No. ZGI.003A) entitled “Apparatus and Method for Custom Molding an Insole” (inventor: Patrik Louko) which is concurrently filed with this application and is incorporated herein by reference.

The 3D scanner 10 scans the molded insoles 20 to generate a scanned image. In some embodiments, the 3D scanner 10 includes a camera. The camera can be rotated clockwise and/or counterclockwise to scan at least an arched middle foot and a rear foot portion of each of the molded insoles 20. The 3D scanner 10 can be any type of 3D scanner as long as it can scan at least middle and rear foot portions of the molded insoles 20. The 3D scanner 10 can transmit the generated scanned image to the computing device 30.

The computing device 30 can store and process the received scanned image for 3D printing. The processing can include, but not limited to, cleaning up the scanned image, such as by noise reduction or removal (e.g., blendering), and subsequent processing to make the scanned and stored image suitable for 3D printing. The computing device 30 can also include a 3D scanning program such as Skanect (available from Occipital) that controls the camera of the 3D scanner 10. The computing device 30 can provide the processed image to the 3D printer 40.

The computing device 30 can include a processor configured to process the scanned image. The processor may have a configuration based on, for example, i) an advanced RISC machine (ARM) microcontroller and ii) Intel Corporation's microprocessors (e.g., the Pentium, Atom, Celeron or Core families of microprocessors). In one embodiment, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 7/8/Vista/2000/9x/ME/XP, Macintosh OS (10), OS/2, Android, iOS and the like. The computing device 30 can be any computing device, including but not limited to, a desktop computer, a laptop computer, a tablet computer, a smartphone, a personal digital assistant or any other computing device that can wirelessly or connectedly communicate data with the 3D scanner 10 and the 3D printer 40.

The 3D printer 40 three-dimensionally prints one or more molds from a printing material based on the scanned image which is used to reproduce insoles that are substantially the same as the previously molded insoles 20. The 3D printer 40 can be any type of 3D printer as long as it can print in 3D one or more molds having rear foot and middle foot portions substantially the same as those of the molded insoles 20. The 3D printer 40 can concurrently print a plurality of pairs of molds with each pair corresponding to a previously molded user's or customer's insoles. The 3D printer 40 can also print a first mold having a shape of a partial insole and print a second mold having substantially the same shape as the first mold. In some embodiments, each of the first and second molds includes a rearfoot portion and a midfoot portion but does not include a forefoot portion. An insole reproducing method using the mold(s) 50 will be described in detail later.

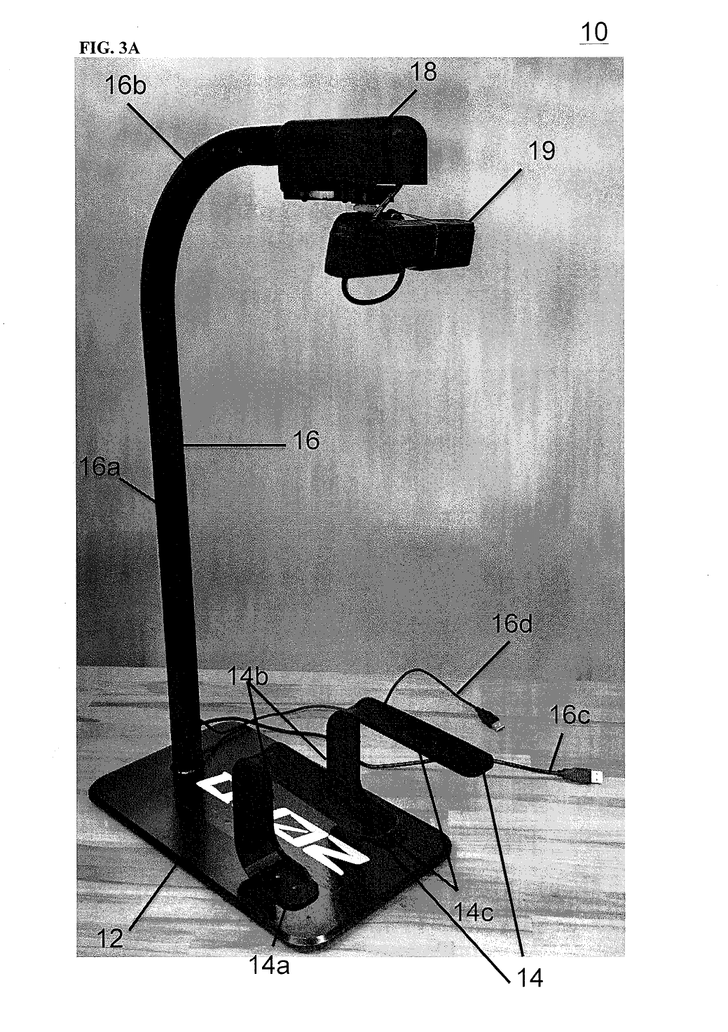

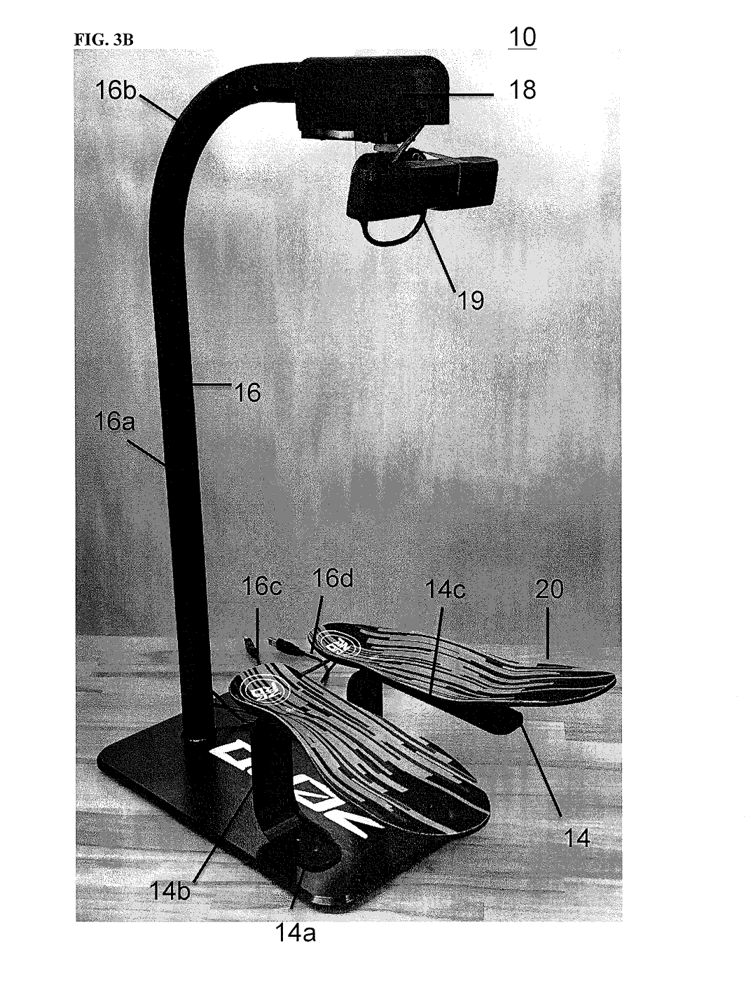

FIG. 3A illustrates an example of a 3D scanner 10 for 3D scanning at least one molded insole according to one embodiment. FIG. 3B illustrates the 3D scanner 10 of FIG. 3A in use in that a pair of molded insoles to be 3D scanned are placed. Referring to FIG. 3A, the 3D scanner 10 includes a body (platform or base unit) 12, an insole stand 14, an extension column 16, a head 18 and a camera 19. The body 12 can function as a base for at least the extension column 16 and the insole stand 14.

The insole stand 14 is attached to the body 12, receives and supports at least one molded insole, for example, a pair of molded insoles as shown in FIG. 3B. In some embodiments, the insole stand 14 is placed below the head 18 and the camera 19 so that the molded insoles 20 placed on the insole stand 14 are captured by the camera 19. The insole stand 14 can include a first portion 14a attached to the body 12, a second portion 14b extending substantially vertically from the first portion 14a and a third portion 14c which extends substantially horizontally from the second portion 14b and on which the insoles 20 are to be placed. The first portion 14a can be attached to the body 12 using, for example, screws, adhesive or other attaching mechanism. Although FIGS. 3A and 3B show two sub-stands of the insole stand 14 on which a pair of insoles 20 are respectively placed, the insole stand 14 may include only one sub-stand that receives only one insole. In another embodiment, the insole stand 14 may include more than two sub-stands that receive three or more molded insoles. For the sake of convenience, the insole stand 14 that accommodates a pair of molded insoles 20 will be described. In some embodiments, each of the molded insoles 20 to be placed on the insole stand 14 has a configuration as shown in FIGS. 2A and 2B. In another embodiment, the molded insoles 20 have other configurations.

The extension column 16 upwardly extends from the body 12 and is connected to the head 18. In some embodiments, as shown in FIG. 3A, the extension column 16 includes a linear portion 16a attached to the body 12 and upwardly extending from the body 12 and a non-linear or curved portion 16b non-linearly extending from the top of the linear portion 16a to the head 18. The height of the linear portion 16a of the extension column 16 may be determined such that the camera 19 can sufficiently scan at least rear foot and middle foot portions of each of the insoles 20 placed on the insole stand 14.

The extension column 16 can be hollow to accommodate a wire or cable (hereinafter to be referred to as “wire”) connected to the camera 19. The extension column 16 can have at least one first opening (not shown) through which a first wire 16c passes to be connected to the computing device 30, for example, via a USB interface. The first wire 16c can also be used to provide power, received from the computing device 30, to the camera 19, via, for example, the USB interface. The extension column 16 can have at least one second opening (not shown) through which a second wire 16d passes to be connected to a separate power supply such as an AC adapter (not shown). The separate power supply can be used to drive motors that are located in the head 18 and rotate the camera 19. In this embodiment, both of the first and second wires 16c and 16d are respectively used for the connection to the computing device 30 and the separate power supply.

The extension column 16 can also be configured such that the camera 19 wirelessly communicates data with the computing device 30. In this embodiment, the extension column 16 may not include the first opening passing through the first wire 16c for the wired connection between the camera 19 and the computing device 30.

The head 18 can be attached to an end of the extension column 16. For example, the head 18 is attached to the curved portion 16b of the extension column 16. The head 18 can accommodate and/or support the camera 19. The head 18 can also support the camera 19 such that the camera 19 rotates clockwise and/or counterclockwise. The head 18 can also include at least one motor that rotates the camera 19. The camera 19 is attached to the head 18 and faces the insole stand 14. The camera 19 can be positioned above the insole stand 14 so as to scan at least the middle foot and rear foot portions of the insole(s) 20 placed on the insole stand 14. For example, the camera 19 is positioned substantially directly above the space between the two sub-stands of the insole stand 14. The camera 19 can be rotated clockwise and/or counterclockwise while scanning each of the insoles 20. The degree of rotation of the camera 19 can be adjusted as long as the camera 19 can scan the midfoot and rearfoot portions of each of the insoles 20. For example, the camera 19 can be rotated up to about 180 degrees. As another example, the camera 19 can be rotated less than or more than about 180 degrees. One of the head 18 and the camera 19 can include a switch configured to turn or off the rotating operation of the camera 19.

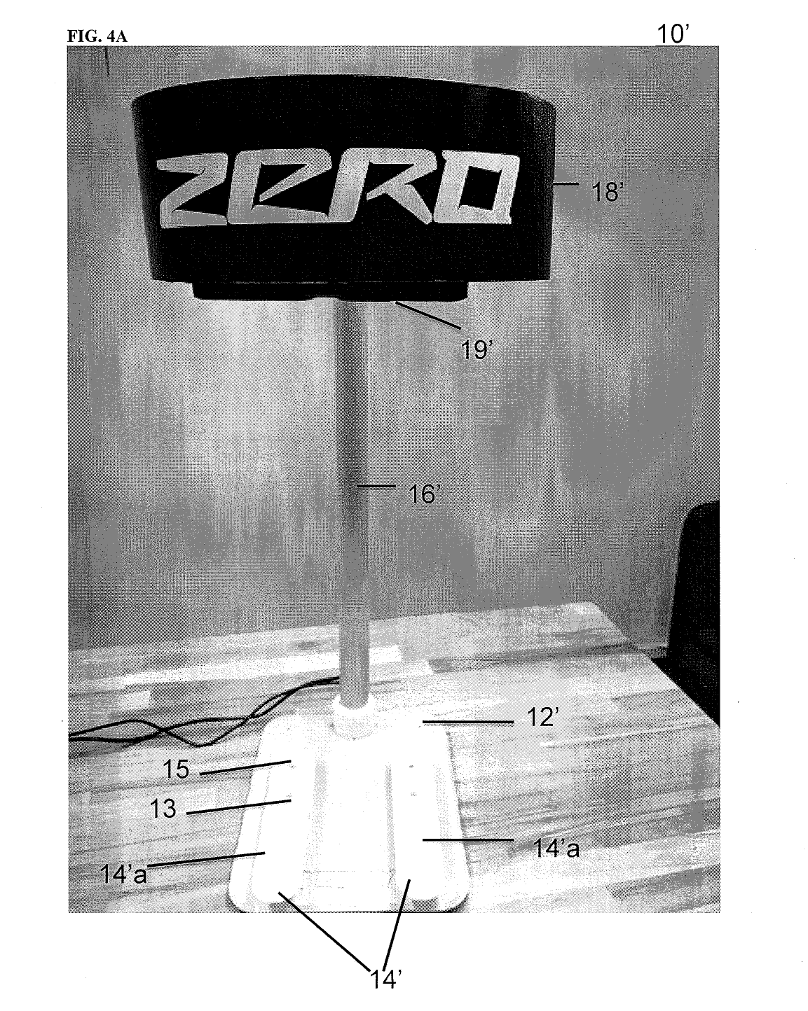

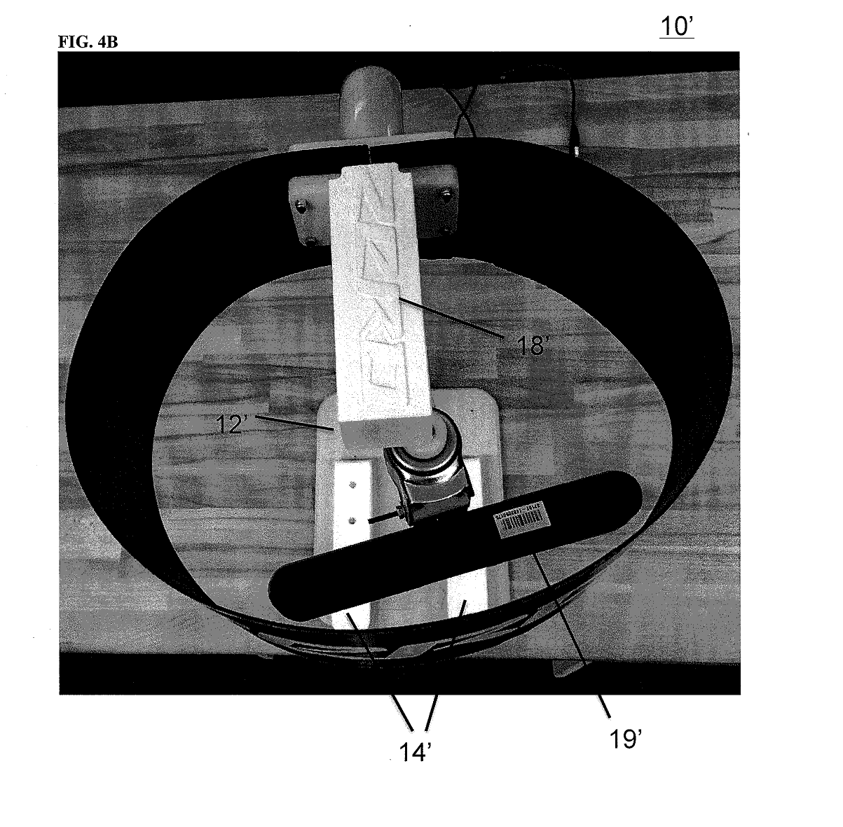

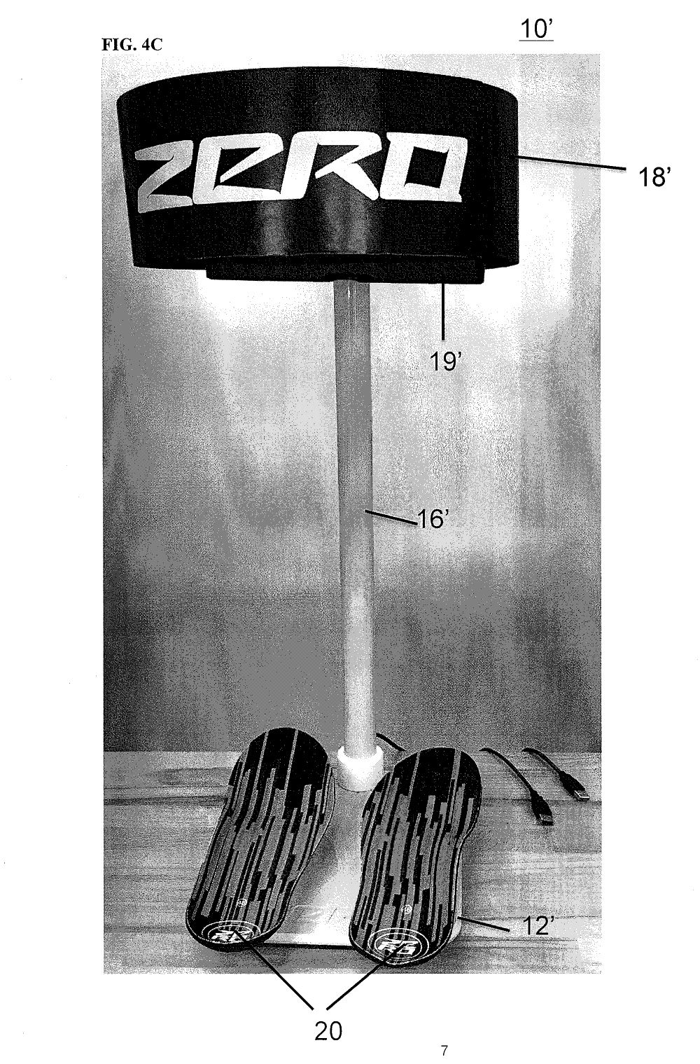

FIG. 4A illustrates an example of a 3D scanner 10′ for 3D scanning at least one molded insole according to another embodiment. FIG. 4B is a detailed view of the camera 19′ of the 3D scanner 10′ of FIG. 3. FIG. 4C illustrates the 3D scanner 10′ of FIG. 4A on which a pair of molded insoles 20 to be 3D scanned are placed. The 3D scanner 10′ includes a body 12′, an insole stand 14′, an extension column 16′, a head 18′ and a camera 19′. Although the function of the 3D scanner 10′ of FIGS. 4A-4C is substantially the same as the 3D scanner 10 of FIGS. 3A and 3B, the structures and/or shapes of the insole stands 14/14′, the extension columns 16/16′, the heads 18/18′ and the cameras 19/19′ are different from each other as described below. The description of the same elements will be omitted for brevity.

For example, the insole stand 14′ does not include a vertical portion vertically extending from the body 12′ and only includes a horizontal portion 14′a on which the insoles 20 are to be placed. Since the vertical portion is omitted in this embodiment, the height of the extension column 16′ can be reduced. One or more holes 13 and 15 may be formed in the horizontal portion 14′a. These holes 13 and 15 can be used to accommodate screws or other attaching members that attach the insole stand 14′ to the body 12′. These holes 13 and 15 can also be used to align the insoles 20 with the camera 19′. For example, the border between the midfoot portions and the forefoot portions of the insoles 20 can be placed on or adjacent to the hole 13 as shown in FIG. 4C. In another embodiment, the holes 13 and 15 are omitted, and an adhesive or other attaching material can be formed between the insole stand 14′ and the body 12′ to attach the two elements 12′ and 14′. In this embodiment, a mark (e.g., line or coloring) can be provided adjacent to an end of the insole stand 14′ for the assistance of the camera-insole alignment procedure.

The extension column 16′ may include only a linear portion attached to and upwardly extending from the body 12′. Alternatively, even if a non-linear or curved portion is provided, the length of such a non-linear or curved portion can be significantly less than that of the non-linear or curved portion 16b, as shown in FIGS. 3A and 3B.

A cross-section of the head 18′ can have a substantially circular shape or other polygonal shape. The head 18′ can accommodate at least a portion of the camera 19′ as shown in FIGS. 4A-4C. The head 18′ can also accommodate at least one motor that rotates the camera 19′. The camera 19′ can have a substantially linear shape and can be wider than the camera 19 of the FIG. 3 embodiment.

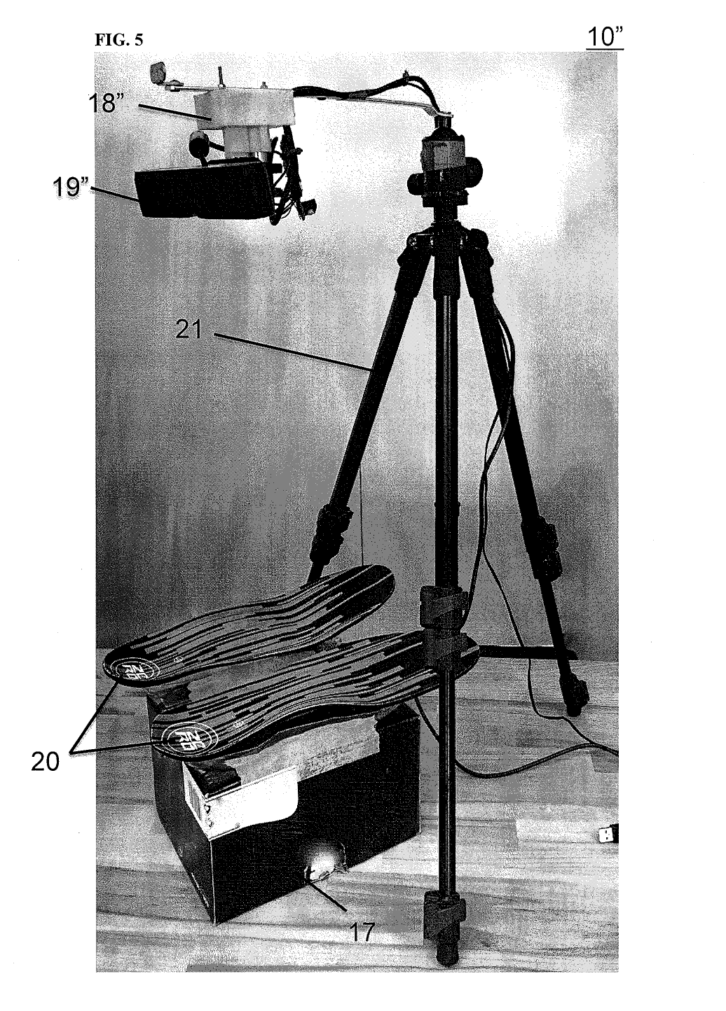

FIG. 5 illustrates an example of a 3D scanner 10″ for 3D scanning at least one molded insole according to another embodiment. The 3D scanner 10″ includes a multi-leg support structure 21, a head 18″ and a camera 19″. In the present embodiment, the insole stand 14/14′ of the previous embodiments is omitted, and the molded insoles 20 can be placed under the camera 19″. For example, the molded insoles 20 can be placed on an object 17 such as a small box which is used as an insole stand. In another embodiment, the molded insoles 20 can be placed on a floor without any supporting object underneath. Furthermore, the extension column 16/16′ of the previous embodiments is replaced with the multi-leg support structure 21. The multi-leg support structure can have two or more legs to support the head 18″ and the camera 19″. Since the function of the head 18″ and the camera 19″ are substantially the same as those of the previous embodiments, the description of these elements is omitted for brevity.

Some of the elements of the 3D scanner 10 of FIGS. 3A and 3B can be replaced with the corresponding elements of the 3D scanner 10′ of FIGS. 4A-4C and the corresponding elements of the 3D scanner 10″ of FIG. 5. For example, the elements 16-19 of FIGS. 3A and 3B can be respectively replaced with the elements 16′-19′ of FIGS. 4A-4C, and vice versa. Furthermore, the elements 18″ and 19″ of FIG. 5 can be respectively replaced with the elements 18 and 19 of FIGS. 3A and 3B and the elements 18′ and 19′ of FIGS. 4A-4C, and vice versa. As another example, the insole stand 14 of the FIG. 3 embodiment can be replaced with the insole stand 14′ of the FIG. 4 embodiment, and vice versa. Furthermore, the structures and shapes of the 3D scanners 10/10′/10″ shown in FIGS. 3A-FIG. 5 are merely examples, and the described technology is not limited thereto. Thus, as long as the 3D scanner 10/10′/10″ can 3D scan at least the midfoot and rearfoot portions of the molded insoles 20, the 3D scanner 10/10′/10″ can have various other shapes.

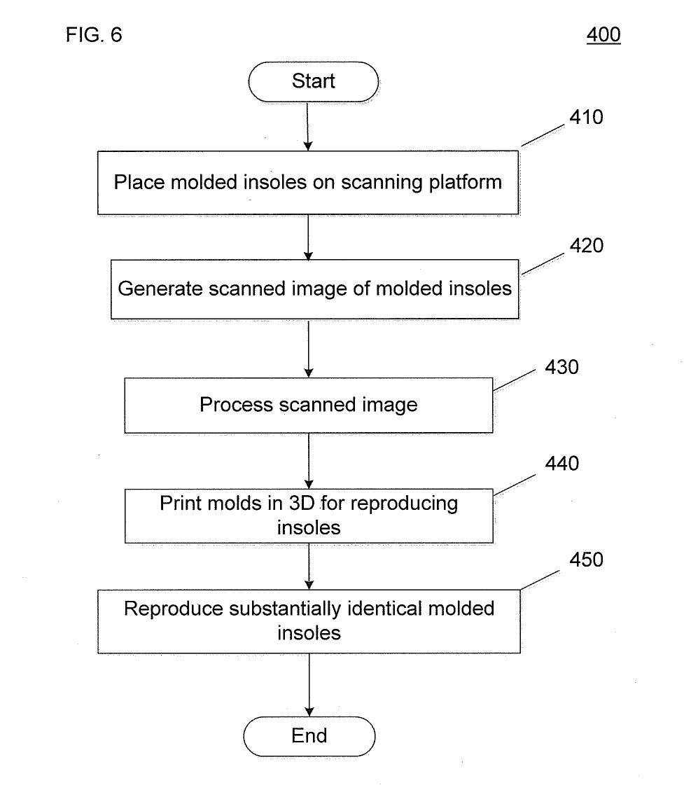

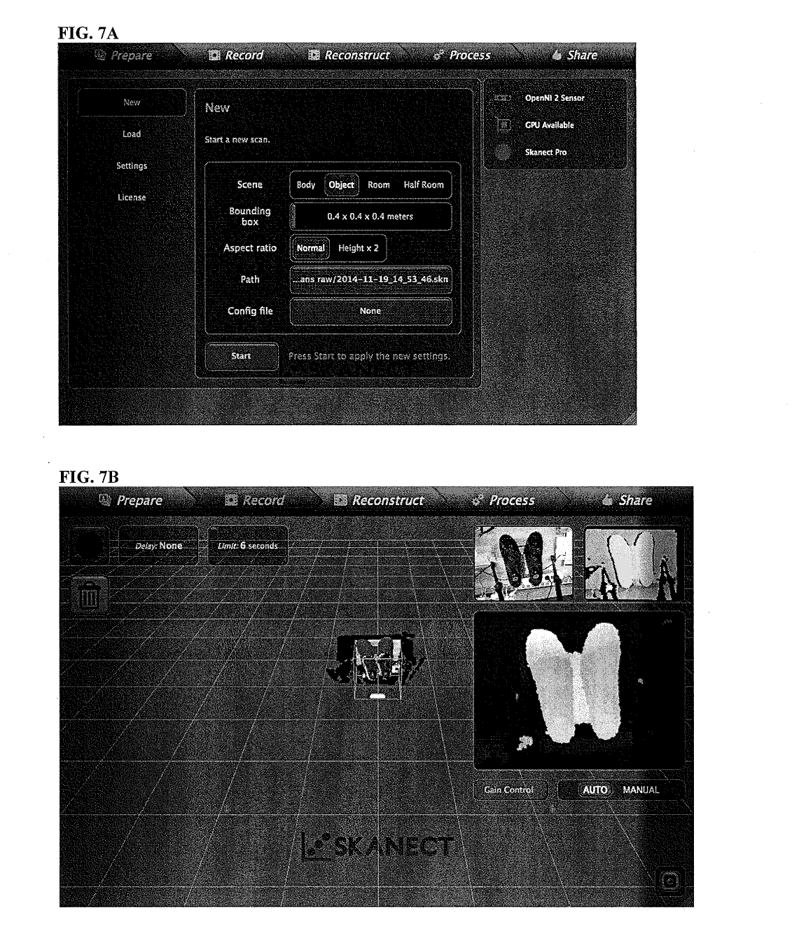

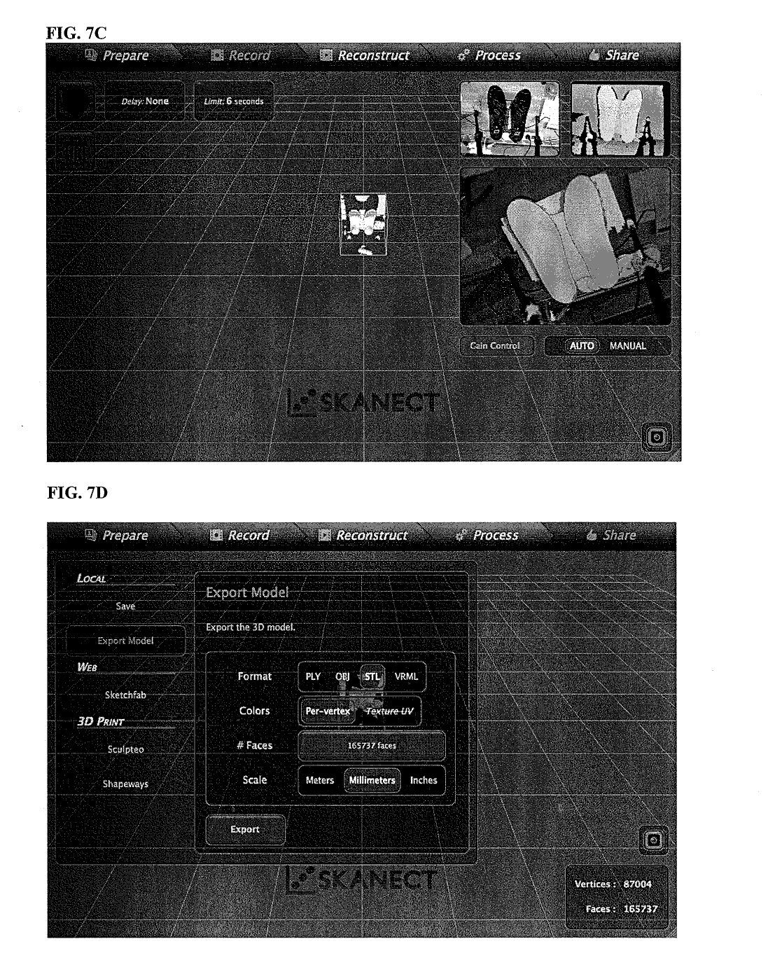

FIG. 6 is a flowchart showing an example of a procedure 400 for reproducing one or more molded insoles. Depending on embodiments, additional states may be added, others removed, or the order of the states changed in the procedure 400 of FIG. 6. Referring to FIGS. 7-14E, a method of reproducing molded insoles will be described.

FIG. 7A is an example of a screenshot of an initial set-up screen of a 3D scanning program (e.g., Skanect described above) according to one embodiment. FIG. 7B is an example of a screenshot of the molded insoles displayed on the computing device 30 of FIG. 1 before the 3D scanner 10 scans the molded insoles 20 according to one embodiment. FIG. 7C is an example of a screenshot of the molded insoles 20 displayed on the computing device 30 of FIG. 1 after the 3D scanner 10 scanned the molded insoles 20 according to one embodiment. FIG. 7D is an example of a screenshot for storing a 3D scanned image as an STL file for processing according to one embodiment. The screenshots shown in FIGS. 7A-7D are merely examples, and the described technology is not limited thereto. This applies to the remaining embodiments.

The molded insoles 20 are placed on a scanning platform such as the insole stand 14/14′ or the object 17 (hereinafter to be interchangeably used with “14”) (410). As discussed above, proper positioning of the insoles 20 on the insole stand 14 allows the camera 19/19′/19″ (hereinafter to be interchangeably used with “19”) to more accurately 3D scan, particularly, the midfoot and rearfoot portions of the insoles 20.

The 3D scanner 10/10′/10″ (hereinafter to be interchangeably used with “10”) scans the insoles 20 and generates a scanned image of the molded insoles 20 (state 420). A 3D scanning program (e.g., Skanect) installed in the computing device 30 allows a user to 3D scan the molded insoles 20. For the purpose of convenience, a description will be provided based on Skanect. However, the described technology is not limited thereto, and various other 3D scanning programs can be used.

State 420 can include opening the 3D scanning program and providing setting information (e.g., scene, bounding box and aspect ratio, etc.) as shown in FIG. 7A. State 420 can also include starting the program and switching on the camera 19 for testing whether the camera 19 properly rotates. In some embodiments, the camera 19 automatically at least partially rotates to the left and right, e.g., about 180 degrees, when the camera 19 is switched on. State 420 can also include repositioning the insoles 20 in a way that the camera 19 can see the insoles 20, particularly the midfoot and rearfoot portions of the insoles 20. For example, a user can see the screen as shown in FIG. 7B and adjust the position of the insoles 20 to fit as much of the insoles 20 as possible in the screen. When the insoles 20 are properly placed on the insole stand 14, the “Delay” button can be set to none and the “Timer” can be set to, for example, 6 seconds, as shown in FIG. 7B. When the “Record” button on the left of the “Delay” button is pressed, the 3D scanning program can start recording a video to create a 3D scanned image from the recorded video data. State 420 can further include deleting the scanned image and rescanning the insoles 20, for example, when the scanning result is unsatisfactory.

When the scanning is complete, the recorded image can look like a small image in the middle of the screenshot of FIG. 7C. The camera 19 can be switched off when the scanning is complete. State 420 can also include storing the scanned image as a certain image file (e.g., .STL file) for further processing, as shown in FIG. 7D. The file name can have the following format: customer_name_RAW_shoesize_MMDDYY. One example file name can be “John_Doe_RAW_44_031115” under this file format. The above file format is merely an example, and the described technology is not limited thereto, and various other file formats can also be used. This applies to the remaining embodiments. The 3D scanned image file can be stored in a computing device. When the customer/user wishes to purchase the molded insoles again, the file can be retrieved from a system and corresponding molds can be printed in 3D for reproducing substantially identical molded insoles. In another embodiment, the file can be given to the customer/user, and the customer can provide this file to a retail store which can reproduce substantially identical insoles using the file.

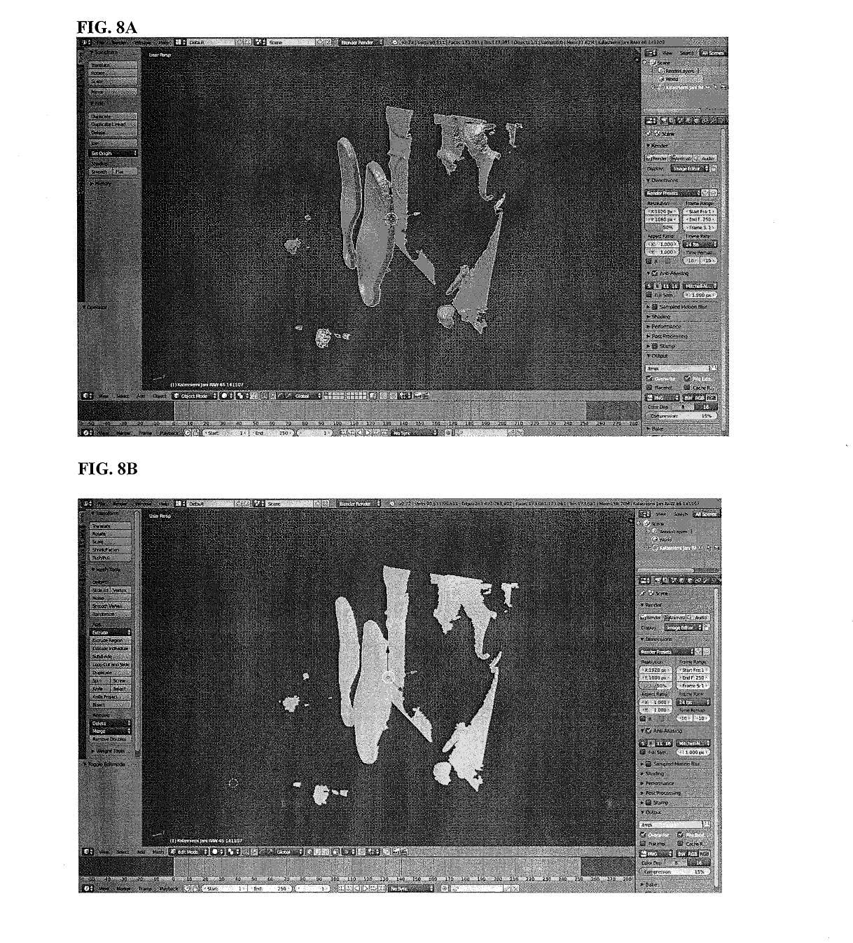

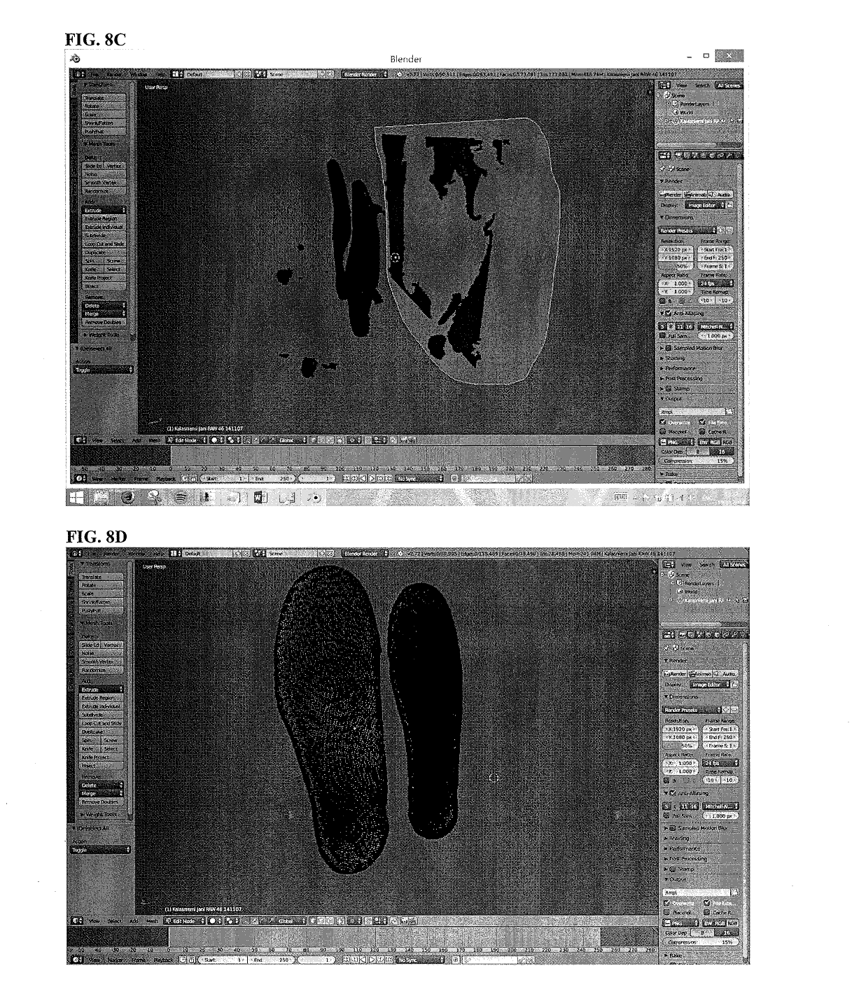

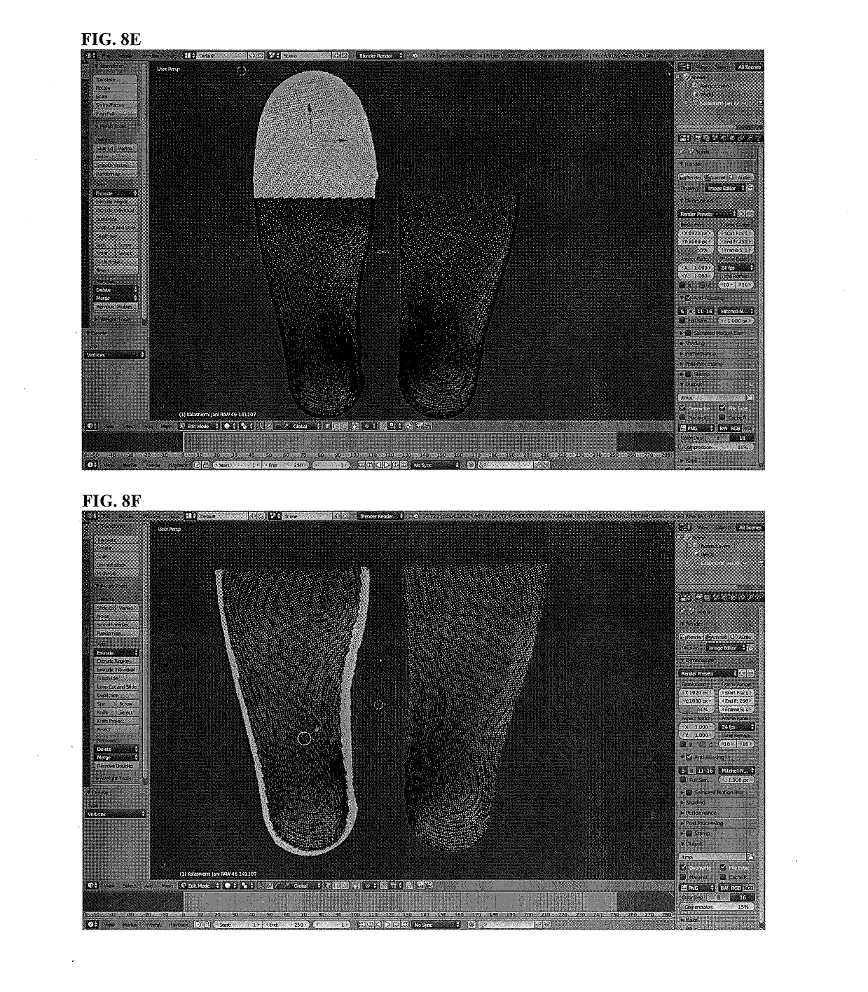

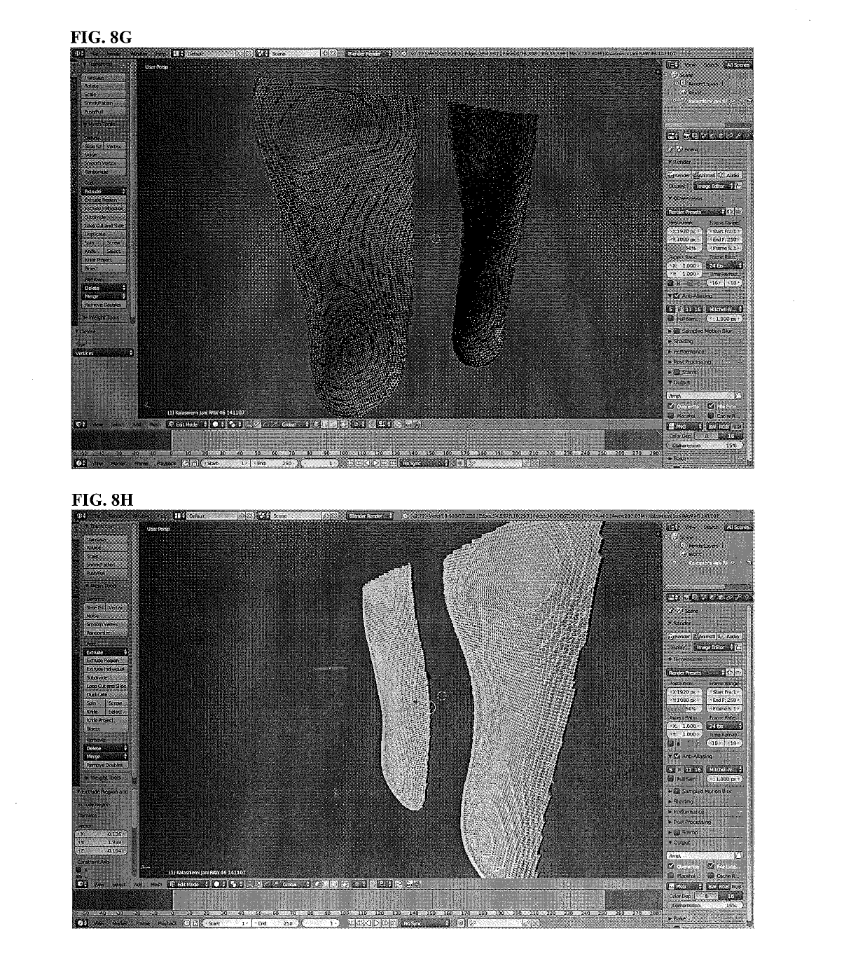

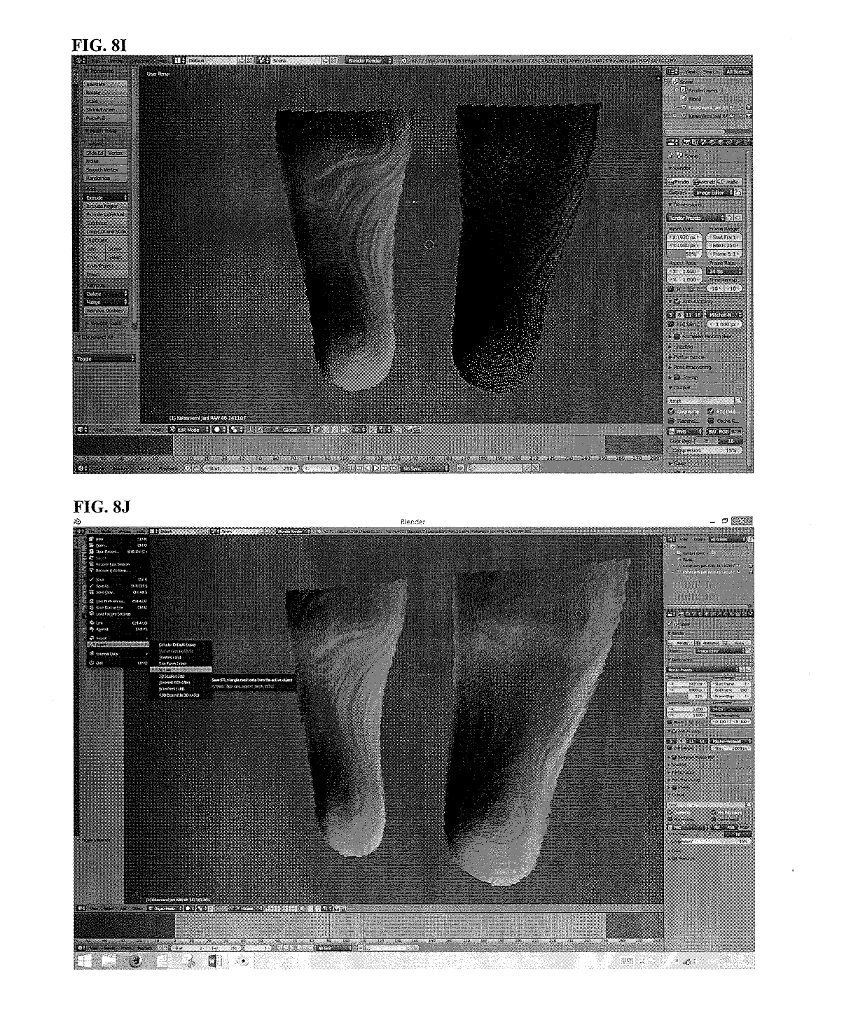

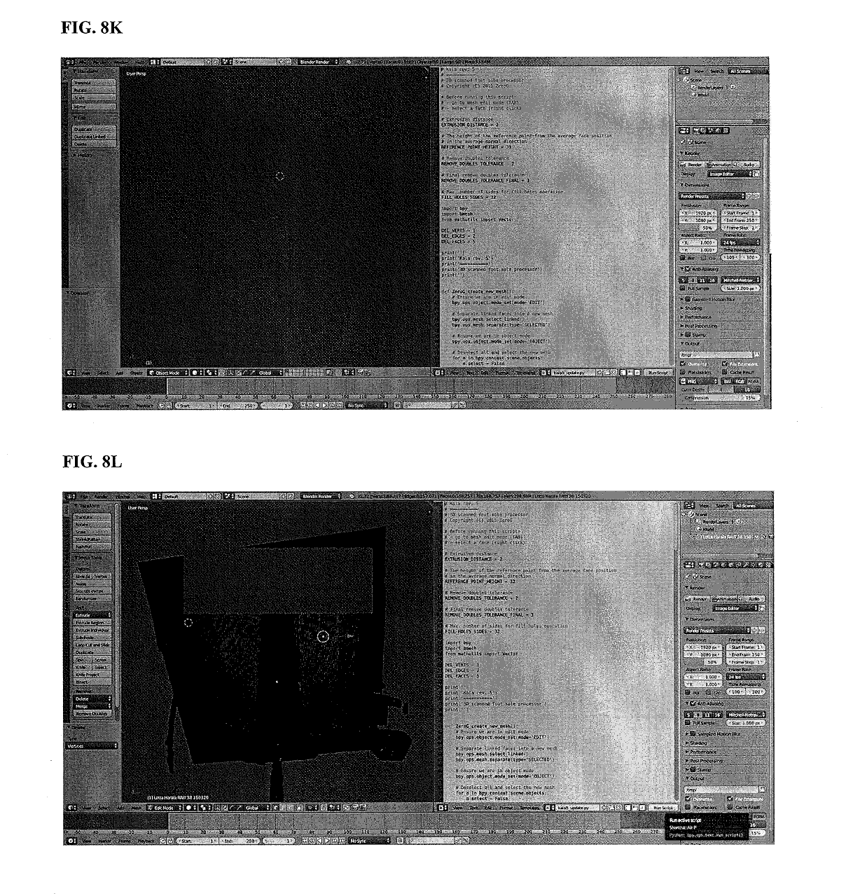

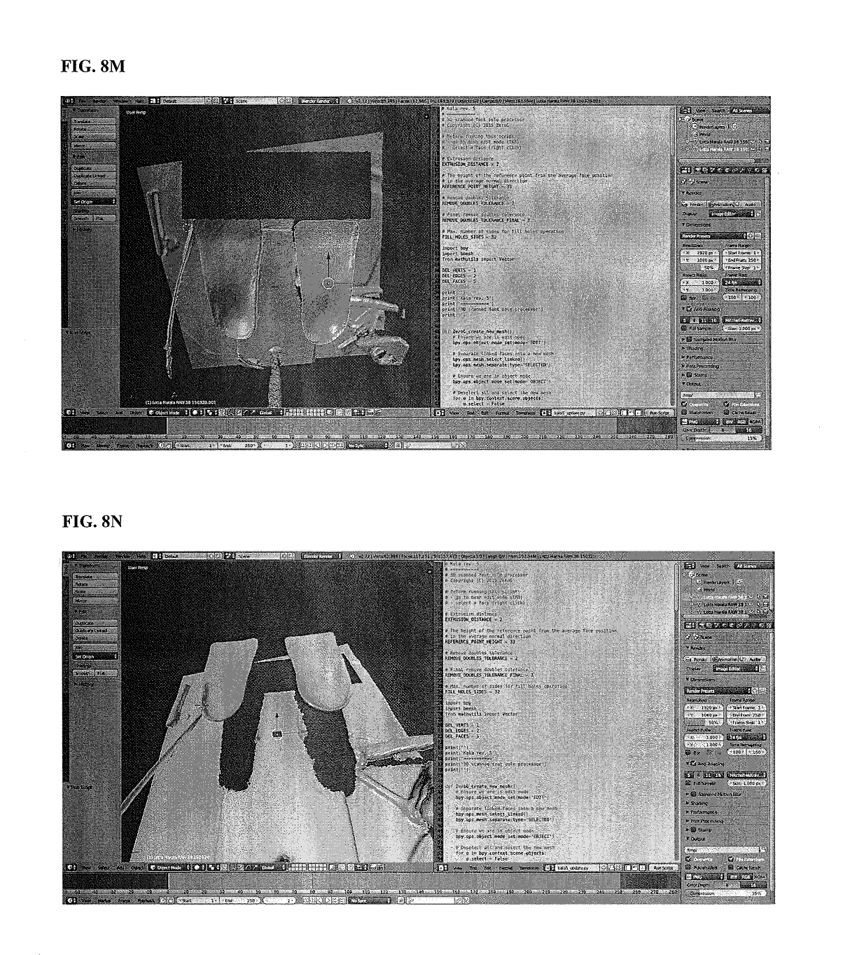

In state 430, the scanned image is processed. State 430 can include refining such as cleaning and subsequent processing to make the 3D scanned image file suitable for 3D printing. FIGS. 8A-8J are example screenshots showing how the scanned image is processed for 3D printing according to one embodiment. Referring to FIGS. 8A-8J, the processing procedure will be described in more detail. As discussed above, the processing can include cleaning the 3D scanned image. The cleaning procedure can be performed by a 3D image processing program such as Blender (available from Blender Foundation). After some preparation for cleaning such as removing images of the camera, cube and lamp from the initial Blender program, and importing the stored STL file, the scanned file can be opened and zoomed out for easy processing, as shown in FIG. 8A. This can be done, for example, by clicking a left mouse button for selecting an area to be cleaned, a right mouse button for moving the 3D scanned image, a middle mouse button for zooming in and out, and pressing the middle mouse button for rotating the 3D scanned image (e.g., moving the mouse to rotate the image and accepting rotation by releasing the middle mouse).

In another embodiment, a certain mouse button (e.g., the middle button of Apple's Magic mouse) can be used to rotate the 3D scanned image, and zoom in and out the 3D scanned image by pressing “Ctrl” and rolling the middle mouse button. Example hotkeys for the Blender program include “A” for selecting/unselecting all, “B” for enabling a box tool, “C” for enabling a circle tool, “X” and “V” for removing a selected mesh, and “Ctrl+left mouse button” for selecting a mesh with a lasso tool. Again, these are merely examples, and many other keys can be used for these functions.

State 430 can include removing informalities or undesirable portions (e.g., a rubbish mesh) from the scanned image in an edit mode. For example, in the edit mode of the Blender program, all the mesh regions to be removed can be selected and removed, for example, with a common editing tool such as a lasso tool of the program, as shown in FIGS. 8B and 8C. The selection can be done by drawing a circle with a mouse around the regions to be removed, and releasing one of the mouse buttons (e.g., left mouse button) to select the mesh inside the loop (the selected area can turn into another color (e.g., orange) and to undo the selection by pressing A (e.g., the unselected area can turn into a different color (e.g., black)). State 430 can include repeating this selection and removal procedure until substantially the entire portion of undesirable images such as trash mesh portions is removed. FIG. 8D shows the scanned image from which trash mesh portions have been substantially removed.

In some embodiments, as shown in FIG. 8E, state 430 further includes removing the forefoot (or tip portion) of the scanned insole image, if the image includes the entire insole. In another embodiment, the scanned image does not include the tip portion and does not need this processing.

State 430 can further include removing surrounding edges of the 3D scanned image. This can be done, for example, by i) pressing hot key “C” to enable a circle tool (see the circle located slightly below the middle portion of the left foot image of FIG. 8F), ii) adjusting the size of the selecting circle with up and down arrows and iii) rolling the middle mouse to select and remove the edges of the 3D scanned image. FIG. 8F shows that the edges of the right foot image have been removed, and the edges of the left foot image are selected for removing. FIG. 8G shows that the edges of both of the right and left foot images have been removed and thus are clean and ready for next steps.

State 430 can further include extruding the surfaces of the cleaned image. This can be done, for example, by finding a region to be extruded from the menu on the left side and left clicking on it, pressing, for example, a minus key, pressing 2 and then entering. If the Blender program renders the scanned image having a certain thickness, for example, 2 millimeters, a user can type −2 to select the bottom of the scanned image. FIG. 8H shows that the cleaned image has been extruded.

State 430 can further include smoothening the bottom portion of the extruded image. This can be done, for example, by selecting “Smooth Vertex” from the menu on the left side and left clicking on it. State 430 can further include separating the smoothened image and saving it into two files for left and right foot images, as shown in FIG. 8I. State 430 can further include exporting the right and left foot images separately into two separate files (e.g., an .STL file), as shown in FIG. 8J. The file name can have the following format: customer_name_Ready_shoesize_MMDDYY. Example file names for both left and right foot images can respectively be “John_Doe_LEFT_readyL_44_031315” and “John_Doe_RIGHT_readyR_44_031315” under this file format.

In some embodiments, the procedures described in FIGS. 8B-8H can be automatically performed as shown in FIGS. 8K-8N. Before the automatic processing, the stored .STL file is opened as shown in FIG. 8K, and one of the two insoles is selected for the automatic processing. The automatic processing can include, for example, running a program (e.g., script program) on the selected insole as shown in FIGS. 8L and 8M. The script program can include, but not limited to, i) identifying and deleting undesirable images from the selected insole, ii) smoothening and cleaning the insole, iii) cutting the insole from heel to the ball of the foot and iv) extruding the insole. The automatic processing can further include, for example, running the script program on the other insole which performs the above procedures i)-iv). The automatically processed insole images, as shown in FIG. 8N, can be exported in the same way as described with respect to FIGS. 8I and 8J.

In state 440, molds are printed in 3D and the 3D printed molds are used to reproduce an earlier version of molded insoles. State 440 can include 3D printing molds using a 3D printing program such as Makerbot (available from Makerbot Industries, LLC). FIG. 9 is an example screenshot of an initial screen of the 3D printing program according to one embodiment. For the purpose of convenience, a description will be provided based on Makerbot. However, the described technology is not limited thereto, and various other 3D printing programs can be used.

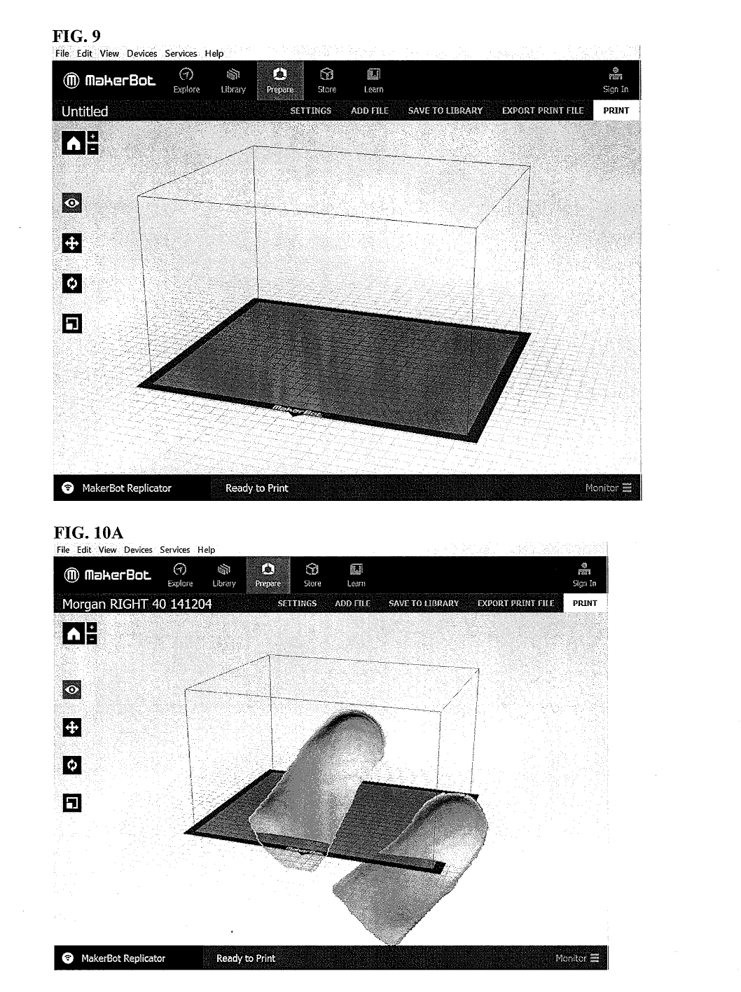

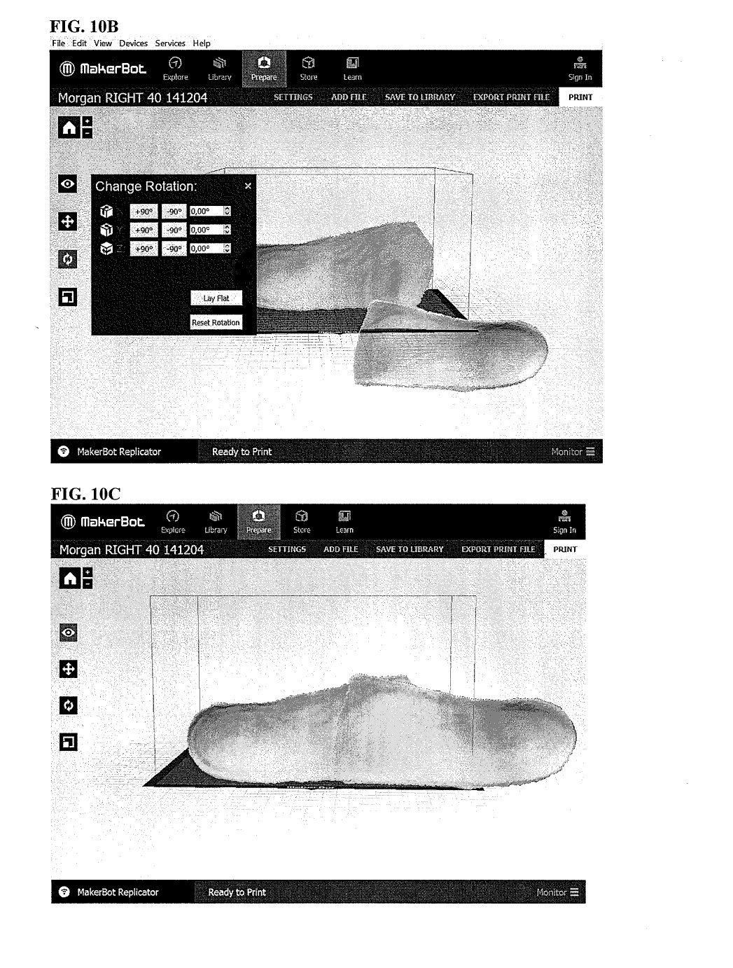

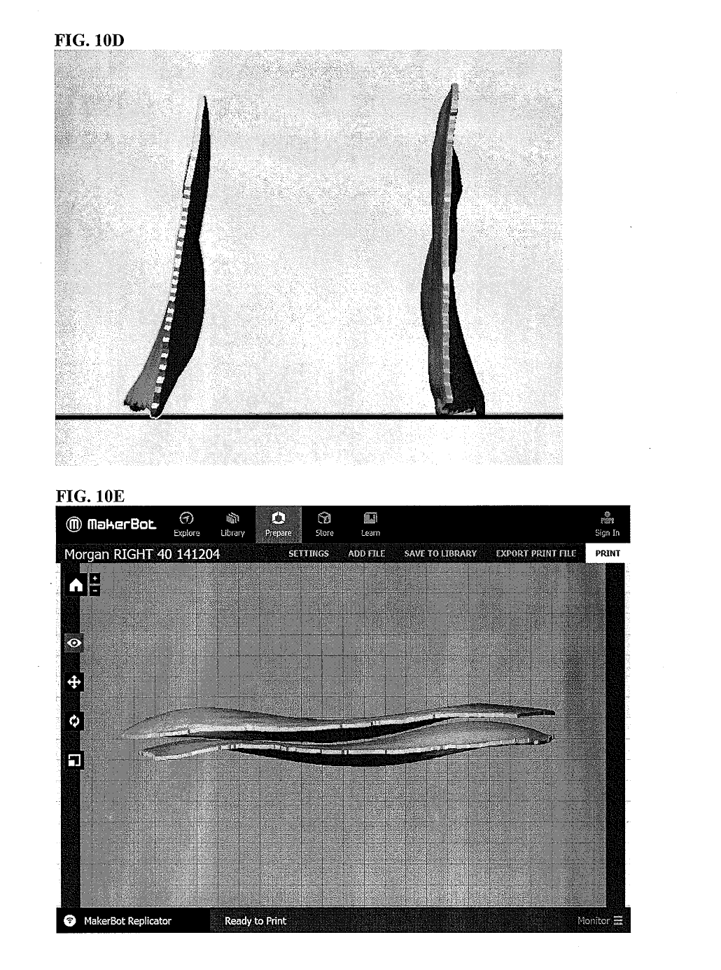

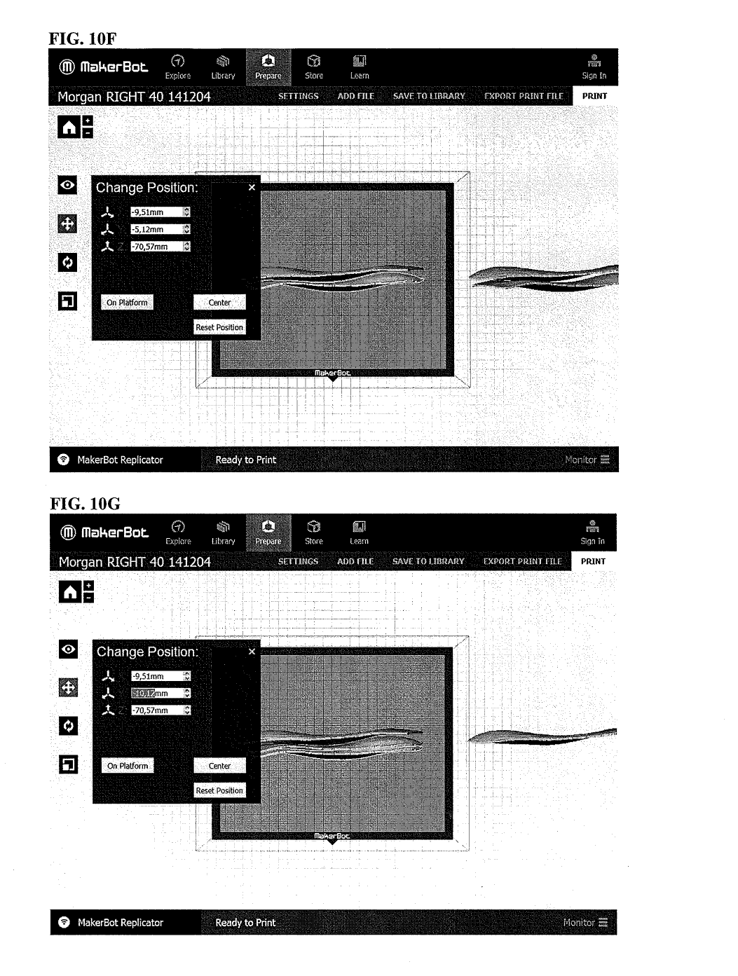

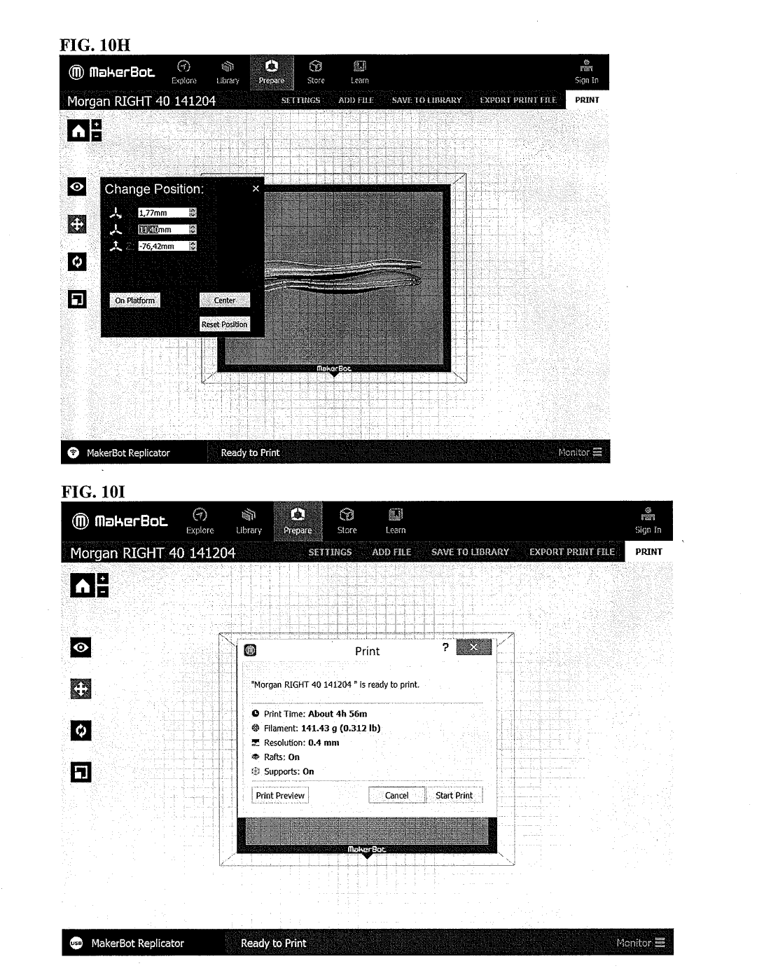

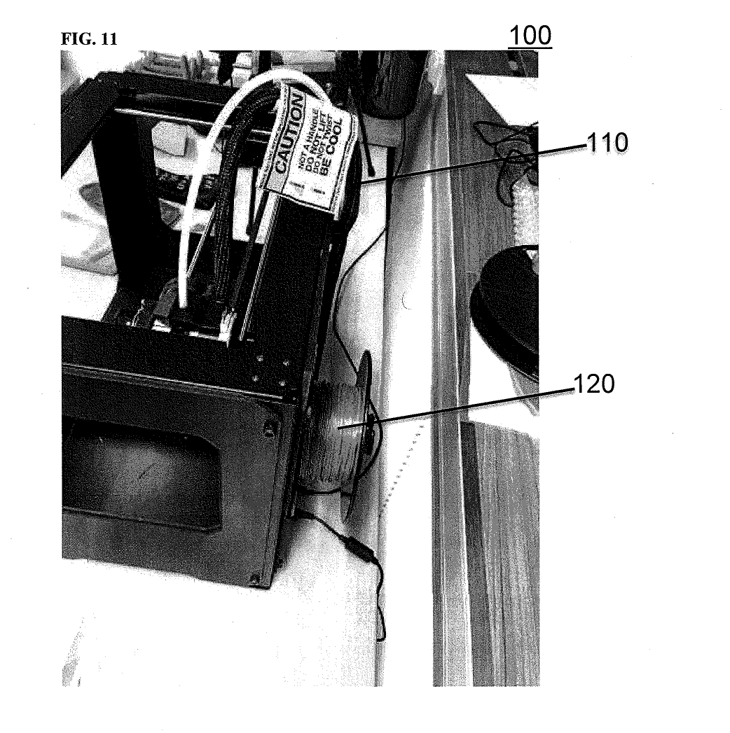

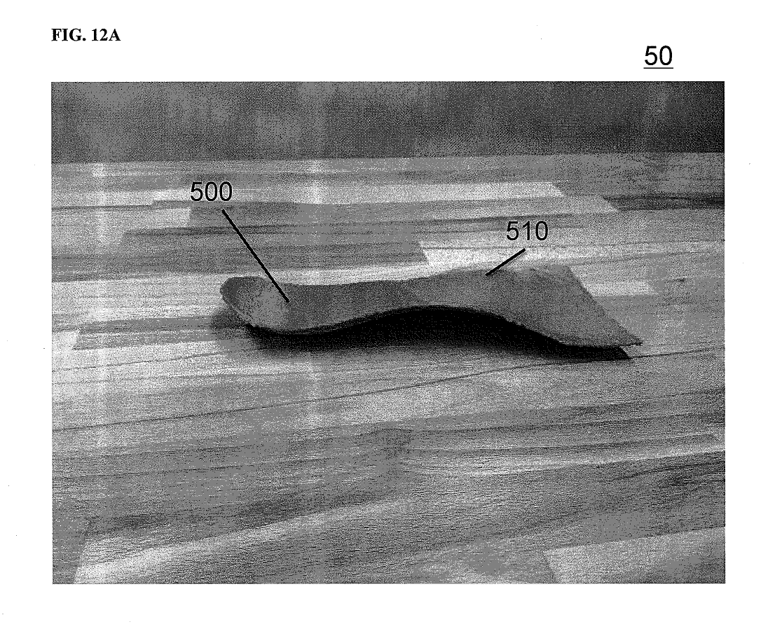

FIGS. 10A-10I are examples of screenshots showing how the scanned and stored images are additionally processed before proceeding to 3D printing according to one embodiment. Referring to FIGS. 10A-10I, a description will be provided as to how the stored images are additionally processed for 3D printing according to one embodiment. State 440 can include reading the 3D scan images that have been processed and stored. This can be done, for example, by pressing “ADD FILE,” at the initial screen of the 3D printing program, and finding an appropriate file from the browser window, for example, for the left and right feet molds. FIG. 10A shows that two image files for the left and right feet molds have been added to the workspace of the 3D printing program.

State 440 can also include placing the molds on a dark grey printing platform and rotating molds so that an arched portion of the foot image is facing the printing platform. The two image files for the left and right feet molds can be rotated such that the lower edges of the molds are substantially parallel to the dark grey platform, as shown in FIG. 10B. State 440 can further include, for example, selecting one of the molds and pressing the “Lay Flat” button, which would place the selected mold on the dark gray printing platform, as shown in FIG. 10C. The other foot mold can be done in the same way.

State 440 can also include examining whether the molds are properly positioned. This can be done, for example, by checking whether the arch is substantially flat on the platform and the mold is securely seated on the printing platform. FIG. 10D shows two comparison images where the left mold has been rotated improperly and the right mold has been rotated properly and appears to be more stably seated than the left mold.

State 440 can further include positioning the molds closer to each other and aligning them, as shown in FIG. 10E. State 440 can further include placing the molds so as not to touch each other, to avoid an undesirable situation where 3D printed molds are attached to each other. State 440 can also include, for example, pressing the “Platform” button to ensure that none of the molds are under the printing platform. State 440 can further include, for example, creating both sets of molds (two pairs of molds for both feet, a total four objects to be printed) by clicking “Ctrl+C” and then “Ctrl+V.”

State 440 can further include selecting the mold in front and checking its coordinates from the “Change Position” window of the 3D printing program, as shown in FIG. 10F. In FIG. 10F, the copy and pasted molds are placed on the right. In some embodiments, only the x-coordinate information changes, and all the other coordinates remain the same. State 440 can further include changing the x-coordinate of the copy-pasted front mold to match and subtract the y-coordinate by 5 such that there is 3 mm space between the two molds, as shown in FIG. 10G. The same procedure can be done to the mold behind (i.e., the next mold). In some embodiments, instead of subtracting the number, 5 can be added to the y-coordinate so that there is the same 3 mm space between the molds. FIG. 10H shows that the molds are ready for printing. State 440 can further include saving the finalized molds, for example, as a THING-file. The file name can have the following format: customer_name_Print_shoesize_MMDDYY. An example file name can be “John_Doe_PRINT_44_031315” under this file format.

State 440 can further include checking a setting profile, for example, ZeroG Settings for the slicer of the 3D printing program. State 440 can further include checking all printing information such as i) whether raft and support materials for 3D printing are switched on, ii) how long it will take to print the molds and iii) how much filament this print will consume, as shown in FIG. 10I.

FIG. 11 illustrates an example of a 3D printer 100 for printing one or more molds for reproducing molded insoles according to one embodiment. State 440 can print molds in 3D from the 3D printer 100 that includes a printer body 110 and a filament 120. The 3D printer 110 can be a typical 3D printer such as Makerbot replicator 2 available from Makerbot Industries, LLC. The filament 120 can be a typical filament such as a flexible filament, an ABS filament or a PLA filament available from Makerbot Industries, LLC. The 3D printer 100 shown in FIG. 11 is merely an example, and the described technology is not limited thereto. For example, various types of 3D printers and filaments can be used, as long as the 3D molds that have been processed as above can be printed in 3D.

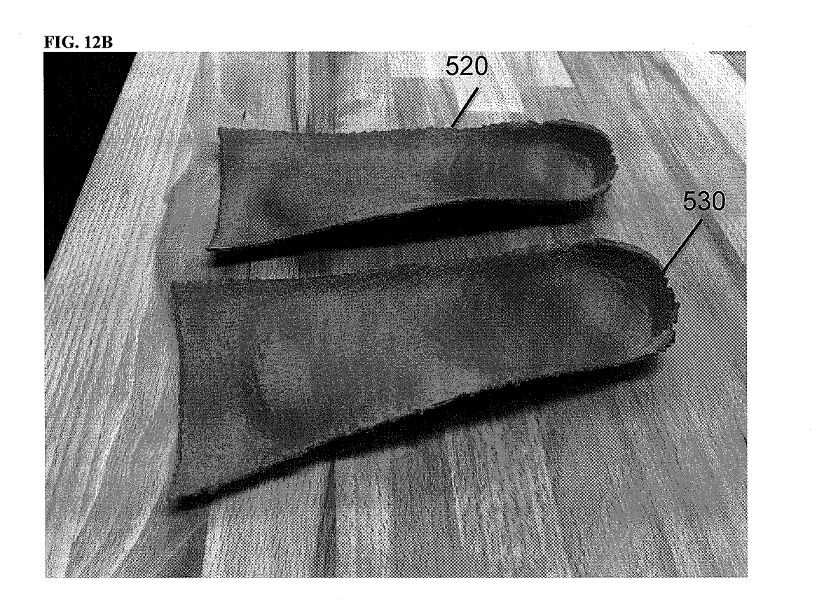

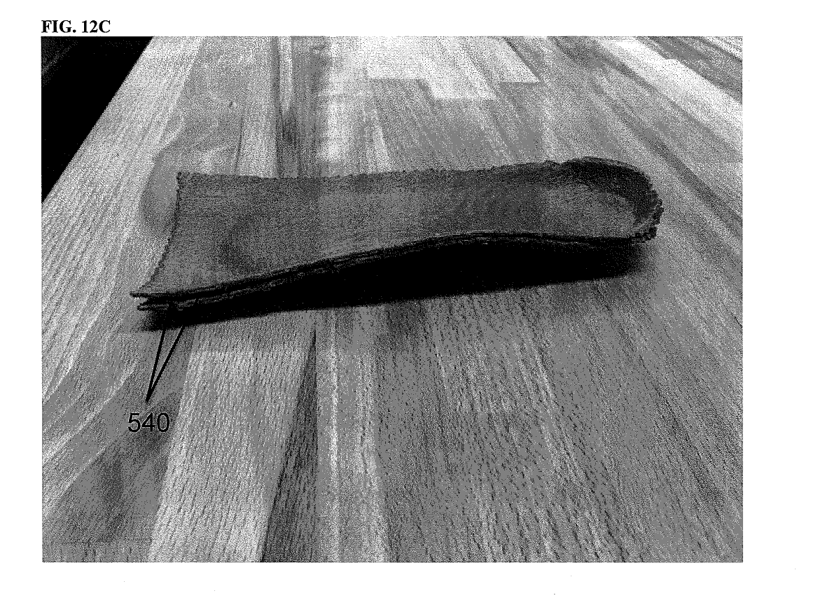

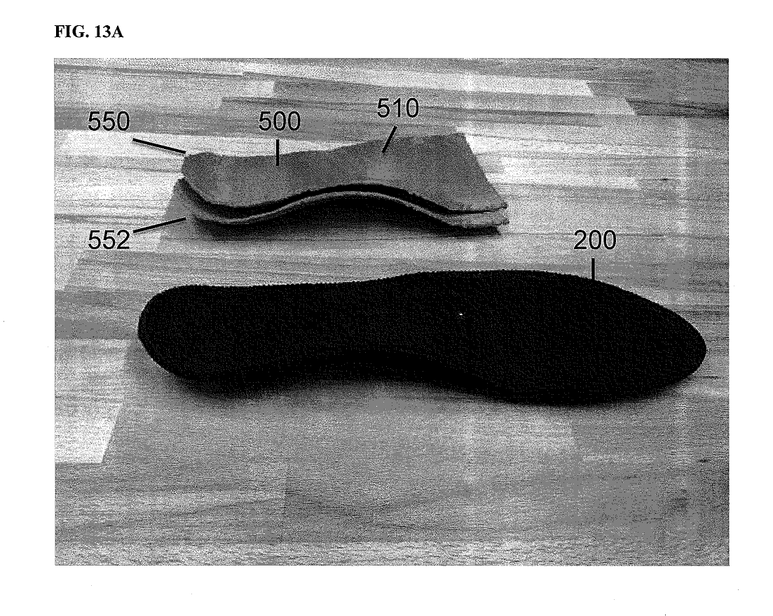

State 440 can include printing at least one mold 50 for reproducing previously molded insoles. FIG. 12A illustrates an example of the mold printed by the 3D printer 110 of FIG. 11 for reproducing the molded insole according to one embodiment. FIG. 12B illustrates examples of the molds having different sizes printed by the 3D printer 110 of FIG. 11 according to one embodiment. FIG. 12C illustrates examples of the molds having the same size printed by the 3D printer 110 of FIG. 11 according to one embodiment. According to the instant embodiments, 3D printed molds vary in size depending on the size of a customer's or user's foot. For example, one mold 530 is greater in size than another mold 520, as shown in FIG. 12B. State 440 can include printing at least two identical molds 540 for the same foot, as shown in FIG. 12C.

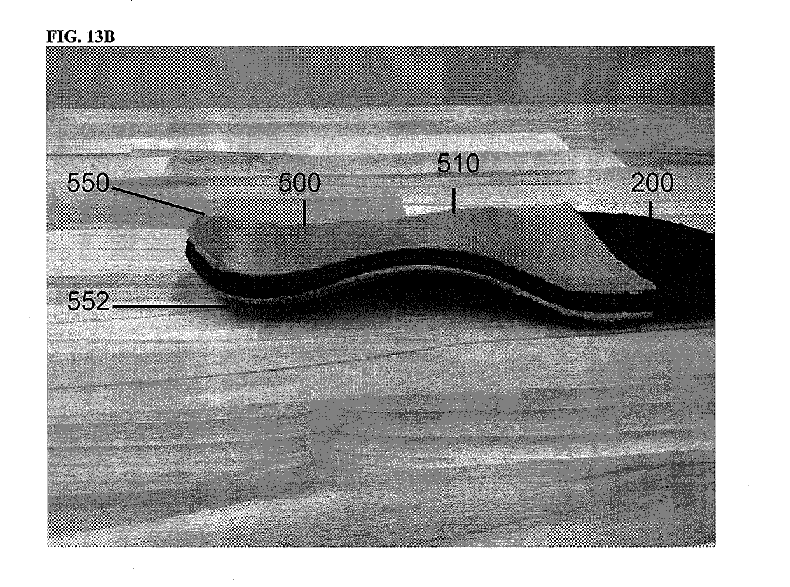

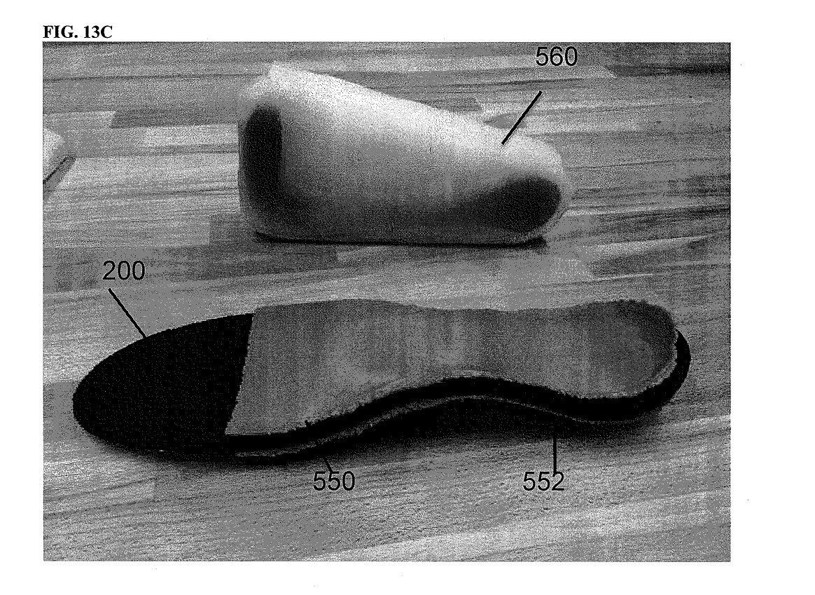

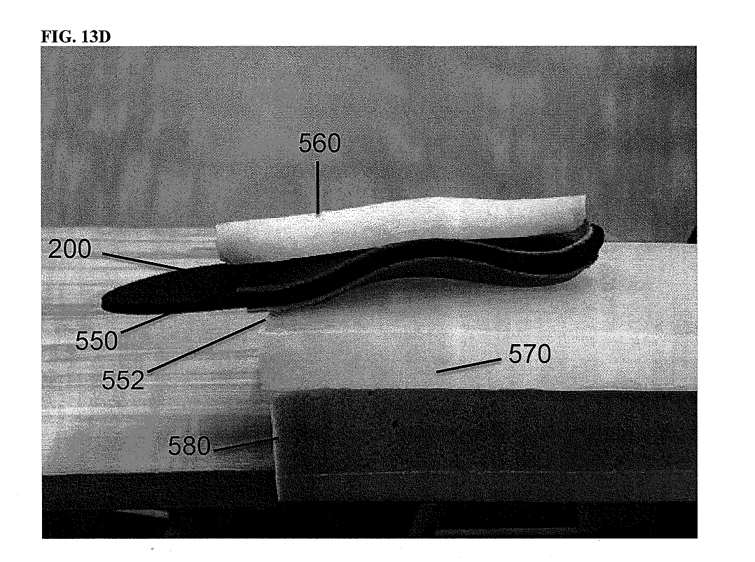

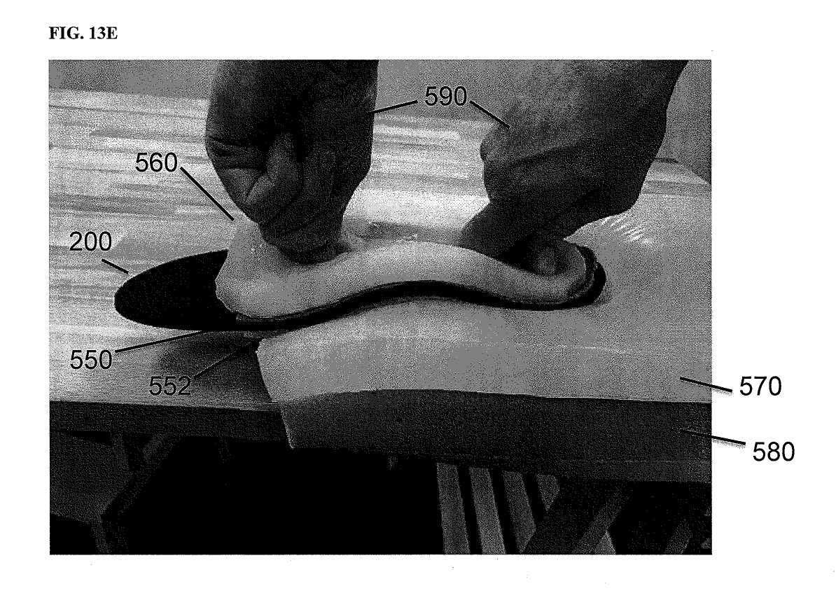

In state 450, substantially identical molded insoles are reproduced based on the 3D printed molds 50. FIG. 13A illustrates examples of molds 550 and 552 having the same size printed by the 3D printer 110 of FIG. 11 and a non-molded insole 200 to be molded by the molds 550 and 552 according to one embodiment. FIG. 13B illustrates the non-molded insole 200 interposed by the molds 550 and 552 of FIG. 13A according to one embodiment. FIG. 13C illustrates the interposed insole 200 and a presser 560 for pressing the molds 550 and 552 in order to mold the insole 200 according to one embodiment. FIGS. 13D and 13E illustrate the non-molded insole 200 being pressed by the presser 560 of FIG. 13C according to one embodiment. Referring to FIGS. 13A through 13E, a procedure of reproducing molded insoles will be described.

State 450 can include preparing the non-molded insole 200 and molds 550 and 552. Two molds are merely examples, and a single mold, or three or more molds can be used to reproduce substantially identical molded insoles. For example, the single mold can be placed above or below the non-molded insole. Furthermore, the three or more molds can be stacked on each other with the non-molded insole interposed therebetween. For the purpose of convenience, a description will be provided based on two molds 550 and 552. The non-molded insole 200 can have the same configuration as that of FIGS. 2A and 2B. Alternatively, the non-molded insole 200 can have a configuration or structure different from that of FIGS. 2A and 2B.

State 450 can include providing a first mold 550 having a shape of a partial insole (e.g., only having rear and middle foot portions) and providing a second mold 552 having substantially the same in shape and size as the first mold 550. In some embodiments, each of the first and second molds 550 and 552 includes a rearfoot portion 500 and a midfoot portion 510 but may not include a forefoot portion, as shown in FIG. 13A. State 450 can include heating the non-molded insole 200 before molding. The heating can be performed at a temperature in the range of about 120° C. to about 140° C. for a time period in the range of about 3 minutes to about 5 minutes. The heating can also be performed for about four minutes at a temperature of about 127° C. However, depending on embodiments, other temperatures and time periods can also be used for heating.

As shown in FIG. 13B, state 450 can also include placing the non-molded insole 200 between the first and second molds 550 and 552 such that the rearfoot and midfoot portions 500 and 510 of the first and second molds 550 and 552 substantially align the rearfoot and midfoot portions of the non-molded insole 200. State 550 can also include providing the presser 560 configured to press at least one of the two molds 550 and 552, as shown in FIG. 13C. The presser 560 can be formed of a gel layer enclosing therein an object or material harder than the surrounding gel layer. The object can be plastic such as ABS or PLA, for example, printed from the 3D printer 110 using the filament 120. The object can also be non-plastic material such as wood, metal, alloy, or a combination thereof.

State 450 can further include pressing at least one of the first and second molds 550 and 552 until the midfoot and rearfoot portions of the non-molded insole 200 are molded to be respectively substantially the same in shape as the rearfoot and midfoot portions 500 and 510 of the first and second molds 550 and 552, as shown in FIG. 13D.

State 450 can further include placing the non-molded insole 200 interposed by the two molds 550 and 552 on a gel layer 570 and a foam layer 580, as shown in FIG. 13D. The gel layer and foam layer can be the same as those described in U.S. patent application (Attorney Docket No. ZGI.003A) entitled “Apparatus and Method for Custom Molding an Insole” (inventor: Patrik Louko) concurrently filed with this application, which is incorporated herein by reference. Furthermore, only one of the gel layer 570 and the foam layer 580 can be used, or alternatively, both of the gel layer 570 and the foam layer 580 can be placed below the molds 550 and 552, as well as below the non-molded insole 200. Moreover, the order of the gel layer 570 and the foam layer 580 can be reversed such that the foam layer 580 is placed over the gel layer 570.

State 450 can further include pressing the upper mold 550 with the presser 560 and hands 590, as shown in FIG. 13E. The pressing can be performed in many other ways. For example, a pressing machine (not shown) can be used to press the molds 550 and 552 (without the use of hands). Alternatively, only a user's hands 590 can be used to press the molds 550 and 552. The presser 560 can enhance the accuracy of reproduced insoles by more precisely forming the arch portions of the rearfoot and midfoot portions of the insole 200. An insole for the other foot can be reproduced in the same way.

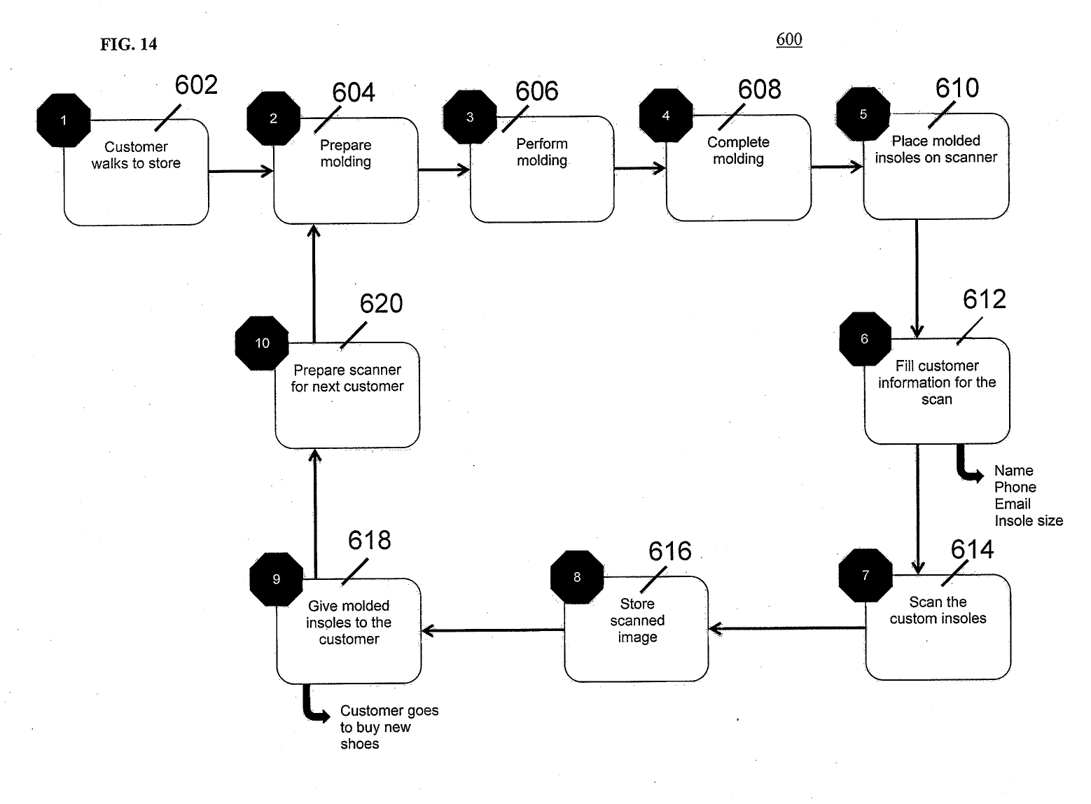

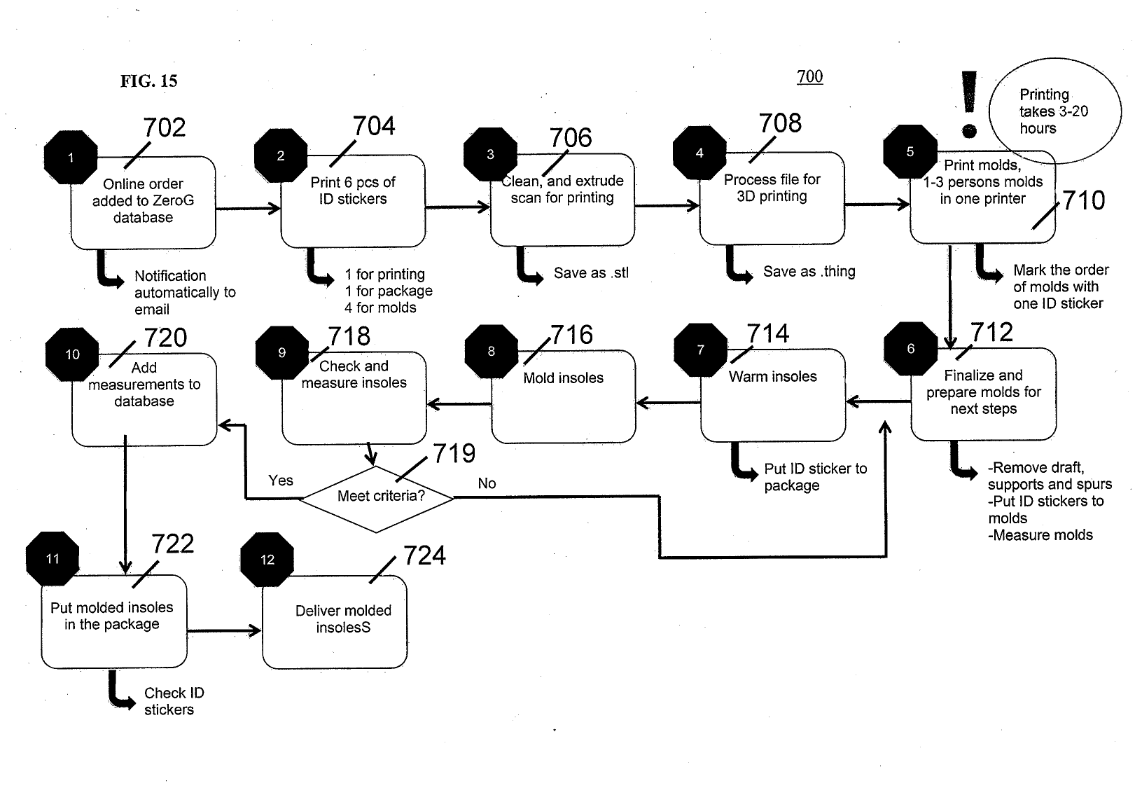

FIG. 14 is a flowchart showing an example of an insole purchasing procedure 600 according to one embodiment. Depending on embodiments, additional states may be added, others removed, or the order of the states changed in the procedure 600 of FIG. 14. This applies to an example insole reproducing procedure 700 of FIG. 15.

In state 602, a customer comes to a store which performs a molding service on insoles that the customer either buys or brings. In state 604, the store prepares a molding (also known as shoedog in the insole molding industry) for the customer, for example, selecting insole sizes and designs, etc. In state 606, the store performs a molding process for the selected insoles. An example molding process is described in U.S. patent application (Attorney Docket No. ZGI.003A) entitled “Apparatus and Method for Custom Molding an Insole” (inventor: Patrik Louko) concurrently filed with this application, which is incorporated herein by reference. In state 608, the molding procedure is complete and the customized insoles can be provided to the customer.

For customers who wish to facilitate future purchases of their reproduced insoles, the store places the molded insoles on a 3D scanner such as the 3D scanner 10 shown in FIG. 1 (state 610). In state 612, before scanning the molded insoles, a retail store employee fills in the customer information for the 3D scan in a computing device, including, but not limited to, name, address, phone number, email address and insole sizes, etc. In state 614, the retail store employee scans the molded insoles. The 3D scanner 10/10′10″ shown in FIG. 3A to FIG. 5 can be used to scan the molded insoles. In state 616, the scanned image is stored, for example, on a location (e.g., Dropbox) of a computing device such as the computing device 30 shown in FIG. 1.

In state 618, the retail store employee gives the molded insoles to the customer. If the customer wishes, the customer can go to buy new shoes in which the molded insoles are placed. In the future, as shown in FIG. 15 and described below, the customer can contact the store and order additional copies of the previously molded insoles, and the store can print in 3D substantially identical molded insoles using the stored 3D scanned image as described above with respect to FIGS. 6 to 13E. The customer may access a website of the store and place an online order for additional insoles. In state 620, the store prepares for the next customer who wishes to purchase customized insoles and create a 3D scanned image for future purchases. Thereafter, the procedure returns to state 604.

FIG. 15 is a flowchart showing an example of an insole reproducing procedure 700 according to one embodiment. In state 702, the retail store employee receives an online order which is added to a store's system database (e.g., ZeroG database). A notification email for the online order can automatically be sent to the customer. In state 704, the store prints, for example, six ID stickers for identification of the order. For example, the six stickers include one sticker for printing, one for a package (that would include reproduced insoles), and four for two pairs of molds. In state 706, the 3D scanned image is processed for printing, such as cleaning and extruding, as described above with respect to FIGS. 8A to 8I. The processed image can be saved as an .STL file.

In state 708, the saved STL file is processed for 3D printing. The preparation can include processing as discussed above with respect to FIGS. 9 to 10I. The file can be saved as a .THING file. In state 710, molds are printed in 3D. In some embodiments, molds for 1-3 people (e.g., four molds per person) are printed in 3D in one printer such as the 3D printer 110 as shown in FIG. 11. However, the described technology is not limited thereto, and molds for more than three people can also be printed at the same time in one 3D printer. Depending on the number of molds to be simultaneously printed, the printing process can take a few hours, for example, about 3 to about 20 hours. However, the described technology is not limited thereto, and the printing process can take less than about three hours, depending on the model of a 3D printer. The retail store employee can mark the order with one ID sticker at this printing stage.

In state 712, the printed molds are finalized and prepared for next steps. The finalization process can include, but not limited to, removing drafts, supports and spurs from the printed molds. The preparation process can include, but not limited to, putting ID stickers on the molds and measuring the printed molds. In state 714, non-molded insoles that match the customer's order are selected and heated for a predetermined time (e.g., about 3 minutes to about 5 minutes) and at a predetermined temperature (e.g., about 120° C. to about 140° C.). One ID sticker can be placed on the package that would include reproduced insoles.

In state 716, the heated insoles are molded using, for example, the procedures as described with respect to FIGS. 13A to 13E. The reproduced insoles are checked for accuracy using predetermined criteria (state 718). The predetermined criteria can include at least one of the heights, curvatures and shapes of the rearfoot and midfoot portions of the molded insoles. One example to check the accuracy is to compare the reproduced insoles with the original (previously molded) insoles with respect to the predetermined criteria. If the molded insoles do not meet the predetermined criteria based on the checking result, the insoles can be discarded and the procedure can return to state 714 to select, heat and mold the new insoles (state 719). The predetermined criteria can have a certain tolerance range, for example, deviation of about 1 mm to about 2 mm or less with respect to the heights, curvatures and shapes of the rearfoot and midfoot portions between the original insoles and the reproduced insoles.

If the molded insoles meet the predetermined criteria, the measured information is added to the system database (state 720). The finalized insoles are placed into their package, after checking the ID stickers (state 722) and delivered to the customer or a retail store for a customer pick up (state 724).

At least one of the disclosed embodiments can reproduce insoles that are substantially identical to previously molded insoles without the need of repeating the same molding procedure. For example, once 3D scanned insole image is created and saved, substantially the same molded insoles can be generated without having customers' insoles molded again and can be provided to customers and/or retail stores for pick-up. Furthermore, customers can easily order the same molded insoles, for example, via phone, email, fax or online, etc., without actually visiting retail stores again. As a result, insole molding costs and time can be significantly reduced while reproducing substantially the same molded insoles. Furthermore, customers do not need to repeatedly visit a retail store for additional molding.

While the above description has pointed out features of various embodiments, the skilled person will understand that various omissions, substitutions, and changes in the form and details of the device or process illustrated may be made without departing from the scope of the appended claims.

What is claimed is:

1. A method of reproducing at least one previously molded insole, comprising:
generating a scanned image of the molded insole;
three-dimensionally printing a mold based on the scanned image; and
reproducing a molded insole, based on the printed mold, which is substantially the same as the previously molded insole.

2. The method of claim 1, wherein the generating is performed with the use of a three-dimensional (3D) scanner.

3. The method of claim 2, wherein the 3D scanner includes a rotatable camera.

4. The method of claim 3, wherein the generating comprises rotating the rotatable camera clockwise and/or counterclockwise to scan at least middle foot and rear foot portions of the molded insole.

5. The method of claim 1, further comprising transmitting the scanned image to a computing device.

6. The method of claim 1, wherein the printing comprises:
printing a first mold having a shape of a partial insole; and
printing a second mold having substantially the same in shape and size as the first mold, wherein each of the first and second molds includes a rearfoot portion and a midfoot portion but does not include a forefoot portion.

7. The method of claim 6, wherein the reproducing comprises:
placing a non-molded insole, including a forefoot portion, a midfoot portion and a rearfoot portion, between the first and second molds such that the rearfoot and midfoot portions of the first and second molds substantially align the rearfoot and midfoot portions of the non-molded insole, wherein the first mold is placed over the second mold; and
pressing at least one of the first and second molds until the midfoot and rearfoot portions of the non-molded insole are respectively substantially the same in shape as the midfoot and rearfoot portions of the first and second molds.

8. The method of claim 1, wherein the printing comprises concurrently printing a plurality of pairs of molds.

9. A system for reproducing at least one previously molded insole, comprising:
a three-dimensional (3D) scanner configured to generate a scanned image of the molded insole; and
a 3D printer configured to three-dimensionally print at least one mold based on the scanned image so as to reproduce at least one molded insole, based on the printed mold, which is substantially the same as the previously molded insole.

10. The system of claim 9, further comprising a computing device configured to process the scanned image and provide the processed image to the 3D printer.

11. A three-dimensional scanner for scanning a molded insole that includes rearfoot, midfoot and forefoot portions, the scanner comprising:
a support structure;
a head connected to a top portion of the support structure; and
a camera attached to the head and configured to be positioned above the insole, wherein the camera is configured to three-dimensionally scan at least the rearfoot and midfoot portions of the molded insole.

12. The scanner of claim 11, wherein the camera is further configured to rotate clockwise and/or counterclockwise while scanning the rearfoot and midfoot portions of the insole.

13. The scanner of claim 12, wherein the camera is further configured to rotate up to about 180 degrees.

14. The scanner of claim 11, wherein the support structure comprises:
a body; and
an extension column upwardly extending from the body, wherein the head is attached to an end of the extension column.

15. The scanner of claim 14, further comprising an insole stand attached to the body and configured to receive and support the insole.

16. The scanner of claim 15, wherein the insole stand comprises a first portion attached to the body, a second portion extending substantially vertically from the first portion and a third portion which extends substantially horizontally from the second portion and on which the insole is to be placed.

17. The scanner of claim 15, wherein the insole stand comprises a horizontal portion which is attached to the body and on which the insole is to be placed.

18. The scanner of claim 11, wherein the support structure comprises a multi-leg structure, and wherein the head is attached to a top portion of the multi-leg structure.

19. The scanner of claim 11, further comprising a processor configured to process the scanned image for three-dimensional printing.

20. A method of reproducing at least one previously molded insole, comprising:
providing a first mold having a shape of a partial insole;
providing a second mold having substantially the same in shape and size as the first mold, wherein each of the first and second molds includes a rearfoot portion and a midfoot portion but does not include a forefoot portion;
placing a non-molded insole, including a forefoot portion, a midfoot portion and a rearfoot portion, between the first and second molds such that the rearfoot and midfoot portions of the first and second molds substantially align the rearfoot and midfoot portions of the non-molded insole, wherein the first mold is placed over the second mold; and
pressing at least one of the first and second molds until the midfoot and rearfoot portions of the non-molded insole are respectively substantially the same in shape as the midfoot and rearfoot portions of the first and second molds.

21. The method of claim 20, further comprising heating the non-molded insole before the placing at a temperature in the range of about 120° C. to about 140° C. and for about 3 minutes to about 5 minutes.

22. The method of claim 20, wherein the pressing comprises pressing the at least one of the first and second molds with the use of a presser.

23. The method of claim 22, wherein the presser comprises a plastic material and a gel layer enclosing the plastic material.

24. The method of claim 20, wherein the pressing is performed such that the height and curvature of the rearfoot and midfoot portions of the insole are substantially the same as those of the rearfoot and midfoot portions of the first and second molds.

25. A molded insole manufactured by the method of claim 20.
